(19) United States
(12) Patent Application Publication
(10) Pub. No.: US 2026/0342425 A1
(43) Pub. Date: Oct. 29, 2026

(54) DATA COLLECTION METHOD AND APPARATUS, AND DEVICE AND STORAGE MEDIUM

(71) Applicant: Beijing Xiaomi Mobile Software Co., Ltd., Beijing (CN)

(72) Inventor: Mingju LI, Beijing (CN)

(73) Assignee: Beijing Xiaomi Mobile Software Co., Ltd., Beijing (CN)

(21) Appl. No.: 19/142,853

(22) PCT Filed: Dec. 30, 2022
(86) PCT No.: PCT/CN2022/144235

§ 371 Date: Jun. 24, 2025

(51) Int. Cl. H04B 7/06; H04W 24/10

(52) U.S. Cl. CPC H04B 7/06966; H04W 24/10

(57) ABSTRACT

The present disclosure relates to a data collection method and apparatus, and a device and a storage medium. The method comprises: receiving data collection instruction information; and measuring a reference signal on the basis of the data collection instruction information, so as to obtain sample data. By means of data collection instruction information, a terminal is instructed to collect corresponding sample data, such that when a beam prediction model is operated, the sample data, which is collected by the terminal, can be used for carrying out operations, thereby improving the accuracy of an output result from the beam prediction model.

### TECHNICAL FIELD

The present disclosure relates to the field of communication technologies, and in particular to a method and apparatus and device for collecting data, and a storage medium.

### BACKGROUND

In New Radio (NR), especially when a communication frequency band is in frequency range 2, due to the rapid attenuation of high-frequency channels, beam-based transmission and reception are required to ensure coverage.

In some beam management procedures, a network device will configure a reference signal resource set for beam measurement. A terminal measures reference signal resources in the reference signal resource set, and the terminal reports identities (IDs) of some stronger reference signal resources and the corresponding layer 1 reference signal received powers (L1-RSRPs) and/or layer 1 signal to interference plus noise ratios (L1-SINRs) to the network device.

In a current traditional method, the reference signal resource set configured by the network device includes X reference signals, and each reference signal corresponds to a different transmit beam of the network device. For at least one reference signal, the terminal needs to measure all receive beams for the reference signal. Therefore, the number of beam pairs that the terminal needs to measure is M*N, where M represents the number of transmit beams of the network device, and N is the number of receive beams of the terminal.

In some cases, in order to reduce the number of beam pairs measured by the terminal, an artificial intelligence (AI) model can be used for beam prediction. For example, the number of beam pairs that the terminal originally needs to measure is M*N, but due to the existence of the corresponding AI model, for spatial domain beam prediction, the terminal may only need to measure part of the M*N beam pairs. The beam quality of the measured part of the beam pairs is input into the AI model, and the beam information of the M*N beam pairs can be output. For time domain beam prediction, the terminal can measure the beam quality of the beam pairs at historical times, and predict the beam information of the beam pairs at future times through the AI model.

However, the AI model mentioned above needs to undergo model training to be obtained. The model training process requires a lot of data support. Obviously, there is currently no corresponding solution to effectively collect data for AI model training.

### SUMMARY

In order to overcome the problems existing in the related arts, the present disclosure provides a method and apparatus and device for collecting data, and a storage medium.

According to a first aspect of embodiments of the present disclosure, there is provided a method for collecting data, which is applied to a terminal. The method includes: receiving data collection indication information; and measuring a reference signal based on the data collection indication information to obtain sample data.

According to a second aspect of embodiments of the present disclosure, there is provided a method for collecting data, which is applied to a network device. The method includes: sending data collection indication information, wherein the data collection indication information is configured to indicate to a terminal to measure a reference signal to obtain sample data.

According to a third aspect of embodiments of the present disclosure, there is provided an apparatus for collecting data, which is configured in a terminal. The apparatus includes: a receiving module, configured to receive data collection indication information; and measuring a reference signal based on the data collection indication information to obtain sample data.

According to a fourth aspect of embodiments of the present disclosure, there is provided an apparatus for collecting data, which is configured in a network device. The apparatus includes: a sending module, configured to send data collection indication information, wherein the data collection indication information is configured to indicate to a terminal to measure a reference signal to obtain sample data.

According to a fifth aspect of embodiments of the present disclosure, there is provided a device for collecting data, including: a processor; and a memory configured to store executable instructions of the processor; wherein the processor is configured to execute the first aspect and any one of the methods in the first aspect.

According to a sixth aspect of embodiments of the present disclosure, there is provided a device for collecting data, including: a processor; and a memory configured to store executable instructions of the processor; wherein the processor is configured to execute the second aspect and any one of the methods in the second aspect.

According to a seventh aspect of an embodiment of the present disclosure, there is provided a non-transitory computer-readable storage medium, wherein instructions in the storage medium, when executed by a processor of a terminal, enable the terminal to execute the first aspect and any one of the methods in the first aspect.

According to an eighth aspect of an embodiment of the present disclosure, there is provided a non-transitory computer-readable storage medium, wherein instructions in the storage medium, when executed by a processor of a terminal, enable the terminal to execute the second aspect and any one of the methods in the second aspect.

The technical solutions provided by the embodiments of the present disclosure may include the following beneficial effects: the terminal is indicated, through the data collection indication information, to collect the corresponding sample data, so that when a beam prediction model is operated, the sample data collected by the terminal can be used for operation, thereby improving accuracy of an output result of the beam prediction model.

It should be noted that the above general description and the following detailed description are merely exemplary and explanatory and should not be construed as limiting of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain principles of the present disclosure.

FIG. 1 shows a schematic diagram of a wireless communication system according to an embodiment of the present disclosure.

FIG. 2 shows a flowchart of a method for collecting data according to an embodiment of the present disclosure.

FIG. 3 shows a flowchart of another method for collecting data according to an embodiment of the present disclosure.

FIG. 4 shows a flowchart of yet another method for collecting data according to an embodiment of the present disclosure.

FIG. 5 shows a flowchart of still another method for collecting data according to an embodiment of the present disclosure.

FIG. 6 shows a flowchart of another method for collecting data according to an embodiment of the present disclosure.

FIG. 7 shows a flowchart of yet another method for collecting data according to an embodiment of the present disclosure.

FIG. 8 shows a schematic diagram of an apparatus for collecting data according to an embodiment of the present disclosure.

FIG. 9 shows a schematic diagram of another apparatus for collecting data according to an embodiment of the present disclosure.

FIG. 10 shows a schematic diagram of a device for collecting data according to an embodiment of the present disclosure.

FIG. 11 shows a schematic diagram of another device for collecting data according to an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. Implementations set forth in the following description of the embodiments do not represent all implementations consistent with embodiments of the present disclosure.

A communication method involved in the present disclosure can be applied to a wireless communication system 100 shown in FIG. 1. The network system may include a network device 110 and a terminal 120. It can be understood that the wireless communication system shown in FIG. 1 is only illustrative and may further include other network devices, for example, core network devices, radio relay devices, radio backhaul devices, etc., which are not depicted in FIG. 1. Embodiments of the present disclosure do not limit the number of network devices and the number of terminals included in the wireless communication system.

It can be further understood that the wireless communication system according to embodiments of the present disclosure is a network providing a wireless communication function. The wireless communication system may use different communication technologies, for example, Code Division A plurality of Access (CDMA), Wideband Code Division A plurality of Access (WCDMA), Time Division A plurality of Access (TDMA), Frequency Division A plurality of Access (FDMA), Orthogonal Frequency-Division A plurality of Access (OFDMA), Single Carrier FDMA (SC-FDMA), and Carrier Sense A plurality of Access with Collision Avoidance. Networks may be classified into 2nd generation (2G) networks, 3G networks, 4G networks, or future evolved networks, for example, 5th Generation Wireless Communication System (5G) networks according to factors of capacity, rate, latency, etc. of different networks. The 5G networks may also be referred to as new radio (NR) networks. For convenience of description, the present disclosure sometimes refers to a wireless communication network simply as a network.

Further, the network device 110 involved in the present disclosure may also be referred to as a radio access network device. The radio access network device may be a base station, an evolved Node B (eNB), a home base station, a radio relay node, a radio backhaul node, a transmission point (TP), a transmission and receiving point (TPR) or an access point (AP) in a Wireless Fidelity (WIFI) system, etc., or may be a gNB in an NR system, or may be a component or some of devices constituting a base station, etc. When the wireless communication system is a vehicle-to-everything (V2X) communication system, the network device may also be a vehicle-mounted device. It is to be understood that embodiments of the present disclosure do not limit a particular technology and a particular device configuration used by the network device.

Further, the terminal 120 involved in the present disclosure may also be referred to as a terminal device, a user equipment (UE), a mobile station (MS), a mobile terminal (MT), etc., and is a device that provides a user with speech and/or data connectivity. For example, the terminal may be a handheld device, a vehicle-mounted device, etc. which has a radio connection function. Some instances of the terminal include a mobile phone, a pocket personal computer (PPC), a palmtop computer, a personal digital assistant (PDA), a laptop computer, a tablet computer, a wearable device, a vehicle-mounted device, etc. Moreover, when the wireless communication system is the vehicle-to-everything (V2X) communication system, the terminal device may also be a vehicle-mounted device. It is to be understood that embodiments of the present disclosure do not limit a particular technology and a particular device configuration used by the terminal.

In embodiments of the present disclosure, the network device 110 and the terminal 120 may use any feasible wireless communication technology to achieve mutual data transmission. A transmission channel corresponding to the network device 110 sending data or control information to the terminal 120 is called a downlink channel (DL), and a transmission channel corresponding to the terminal 120 sending data or control information to the network device 110 is called an uplink channel (UL). It can be understood that the network device involved in embodiments of the present disclosure may be a base station. Alternatively, the network device may also be any other possible network device, and the terminal may be any possible terminal, which is not limited by the present disclosure.

In the NR, especially when a communication frequency band is in frequency range 2, due to the rapid attenuation of high-frequency channels, beam-based transmission and reception are required to ensure coverage.

In some beam management procedures, a network device will configure a reference signal resource set for beam measurement. A terminal measures reference signal resources in the reference signal resource set, and the terminal reports identities (IDs) of some stronger reference signal resources and the corresponding L1-RSRPs and/or L1-SINR to the network device.

In a current traditional method, the reference signal resource set configured by the network device includes X reference signals, and each reference signal corresponds to a different transmit beam of the network device. For at least one reference signal, the terminal needs to measure all receive beams for the reference signal, so as to obtain beam measurement qualities corresponding to all receive beams, respectively. In some cases, one or more best beam measurement qualities and/or beam identities corresponding to the best beam measurement qualities can be determined. Therefore, the maximum number of beam pairs that the terminal needs to measure is M*N, where M represents the number of transmit beams of the network device, and N is the number of receive beams of the terminal.

In some cases, in order to reduce the number of beam pairs measured by the terminal, an AI model can be used for beam prediction. For example, the number of beam pairs that the terminal originally needs to measure is M*N, but due to the existence of the corresponding AI model, for spatial domain beam prediction, the terminal may only need to measure part of the M*N beam pairs, for example, measure ⅛ of the M*N beam pairs, ¼ of the M*N beam pairs, etc. The beam quality of the measured part of the beam pairs is input into the AI model, and the beam information or the preferred beam information of the M*N beam pairs can be output, where the preferred beam information may include at least one of a preferred transmit beam, a preferred receive beam or a preferred beam pair. The preferred beam pair is a beam pair consisting of the preferred transmit beam and the preferred receive beam. The preferred beam information may indicate a beam whose beam quality predicted by the AI model meets a condition. For time domain beam prediction, the terminal can measure the beam quality of the beam pairs at historical times, and predict the beam information of the beam pairs at future times through the AI model.

In some AI model-based beam prediction scenes, predictions for spatial domain beams may be included. For example, beam information of a beam in set A is predicted based on beam information of a beam in set B, where set B can be a subset of set A, or set B is a wide beam and set A is a narrow beam. Additionally or alternatively, predictions for time domain beams may be included. For example, beam information of set A at a future time is predicted based on beam information of set B at a historical time. In a case of time domain beam prediction, for a relationship between set B and set A, in addition to the fact that set B can be a subset of set A, or set B is a wide beam and set A is a narrow beam, set B can also be the same as set A.

In the related arts, for an implementation process of beam prediction by a beam prediction model, reference may be made to the following manner.

In a case where the beam prediction model is for spatial domain prediction, the terminal measures a L1-RSRP and/or a L1-SINR of set B and inputs it into the AI model. Information of set A that the AI model can predict includes at least one of: a L1-RSRP and/or a L1-SINR corresponding to a beam, and/or a L1-RSRP and/or a L1-SINR corresponding to a beam pair; or a preferred transmit beam ID, a preferred receive beam ID and/or a preferred beam pair ID in set A, where the beam pair includes a transmit beam and a receive beam.

The relationship between set B and set A can include the following two relationships.

A first relationship is that set B is a subset of set A. For example, if set A contains 32 reference signals (each reference signal corresponds to a beam direction), then set B contains some of the reference signals, for example, set B contains 8 reference signals among the 32 reference signals.

A second relationship is that set B is a wide beam and set A is a narrow beam. For example, set A contains 32 reference signals (each reference signal corresponds to a beam direction, and the 32 reference signals cover a 120-degree direction). Set B contains Y other reference signals, for example, Y=8. These Y reference signals cover the same 120-degree direction, that is, a beam direction of each reference signal in set B covers beam directions of a plurality of reference signals in set A. It can be understood that the 32/Y reference signals in set A and a single reference signal in set B are in a quasi co-location (QCL) Type D relationship.

In a case where the beam prediction model is for time domain prediction, the terminal measures a L1-RSRP and/or a L1-SINR of set B at a historical time and inputs it into the AI model to predict at least one of the following of set A at a future time: a L1-RSRP and/or a L1-SINR corresponding to a beam, and/or a L1-RSRP and/or a L1-SINR corresponding to a beam pair; or a preferred transmit beam ID, a preferred receive beam ID and/or a preferred beam pair ID in set A, where the beam pair includes a transmit beam and a receive beam. In addition to the above two relationships between set B and set A, there is another relationship that set B and set A are the same.

In a case where the beam prediction is based on the AI model, and the AI model is for time domain prediction, since the beam information corresponding to the reference signal at the future time can be predicted based on the AI model, the base station may not send the reference signal at the future time. The terminal obtains, based on the measurement result of the reference signal at the historical time and the AI model, the L1-RSRP and/or the L1-SINR of the reference signal at the future time and can report it to the network device.

However, in some solutions that do not use the AI model for beam prediction, the L1-RSRP and/or the L1-SINR corresponding to the reference signal at the future time measured by the terminal also needs to be sent to the base station. That is, the terminal measures the L1-RSRP and/or the L1-SINR at the future time to obtain beam information and reports the beam information to the network device.

It can be understood that a process of operating the AI model may include training the model, monitoring the model performance and deducing the model. Training the model can be to use some existing sample data as input and output labels of the model to train a model for beam prediction, that is, a beam prediction model. Monitoring the model performance may mean that during the use of the model, due to possible changes in the scene, a change in a moving speed of the terminal, and different beam-related parameter configurations of the base station and the terminal, the model performance may not meet service needs, and it is necessary to monitor the model performance to optimize/switch/update the model. Deducting the model refers to providing an input to the model and using the model to obtain the corresponding output. The training of the model requires a large amount of data for training. The performance monitoring of the model also requires a certain amount of data for performance monitoring, and the model deduction also requires some data. However, there is currently no corresponding solution for effectively collecting the data required for the operation of the AI model. As such, how to collect the data needed for the operation of the AI model is a problem that needs to be solved.

Therefore, in the present disclosure, the data collection indication information indicates that the terminal should collect the corresponding sample data, so that when a beam prediction model is operated, the sample data collected by the terminal can be used for operation, thereby improving accuracy of an output result of the beam prediction model.

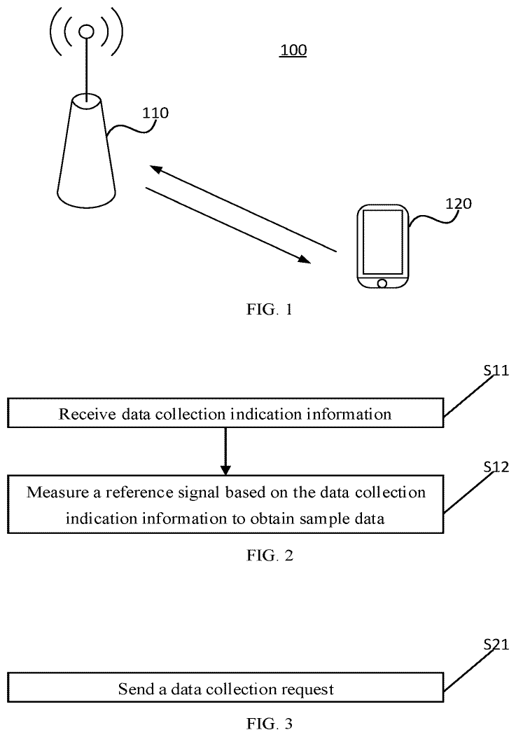

FIG. 2 shows a flowchart of a method for collecting data according to an embodiment of the present disclosure. As shown in FIG. 2, the method is applied to a terminal and may include steps S11 and S12.

In the step S11, data collection indication information is received.

In some embodiments, the terminal may receive the data collection indication information sent by a network device.

It can be understood that the data collection indication information can be used to indicate to the terminal to collect sample data, such as when to measure the reference signal, which reference signals to measure, how much data to collect for the beam prediction model operation, etc. The present disclosure does not limit the content indicated by the data collection indication information.

In some embodiments, the reference signal may be a channel state information reference signal (CSI-RS), a demodulation reference signal (DMRS), a synchronization signal block (SSB), etc., which is not limited in the present disclosure.

In the step S12, a reference signal is measured based on the data collection indication information to obtain sample data.

In some embodiments, the terminal may measure the reference signal based on the data collection indication information received in the S11 to obtain the corresponding sample data. The reference signal may be, for example, a reference signal in one or more reference signal sets.

For example, the data collection indication information received by the terminal indicates which reference signals the terminal measures. It can be understood that in actual applications, the network device often sends a plurality of reference signals, so the plurality of reference signals can be included in one reference signal set. That is, one reference signal set can include one or more reference signals. The terminal can measure a reference signal indicated by the data collection indication information or a reference signal in a reference signal set indicated by the data collection indication information to obtain the corresponding sample data.

For another example, the reference signal measured by the terminal may also be based on protocol provisions or pre-configured. The data collection indication information may indicate when the terminal performs the measurement, such as a time when the measurement starts and/or a time when the measurement ends. The terminal measures, based on the data collection indication information, the corresponding reference signal within the corresponding time. Alternatively, the data collection indication information may also be only used to indicate that the terminal can measure the reference signal. The terminal determines, based on the protocol provisions or a pre-configured manner, which reference signals and/or at what time to measure.

It can be understood that the sample data measured by the terminal may include one or more pieces of data used for the beam prediction model operation. Alternatively, the sample data may further include more possible information according to actual conditions, such as a measurement time, partial identification information, etc., which is not limited in the present disclosure.

In the present disclosure, the data collection indication information indicates that the terminal should collect the corresponding sample data, so that when a beam prediction model is operated, the sample data collected by the terminal can be used for operation, thereby improving accuracy of an output result of the beam prediction model.

In the method for collecting the data provided by embodiments of the present disclosure, the sample data may include input sample data. The input sample data is used as an input when the beam prediction model is operated. The reference signal may include a reference signal in a first reference signal set and/or a second reference signal set, an input of the beam prediction model is beam information corresponding to the reference signal in the first reference signal set, and an output of the beam prediction model is beam information or preferred beam information corresponding to the reference signal in the second reference signal set. The input sample data may include at least one of the following parameters: beam information of a first transmit beam corresponding to the reference signal in the first reference signal set, or beam information of a first beam pair corresponding to the reference signal in the first reference signal set, where the first beam pair includes the first transmit beam and a first receive beam; a reference signal identifier of the reference signal in the first reference signal set; a first receive beam identifier; or a first beam pair identifier.

In some embodiments, the sample data may include the input sample data. The input sample data may be used as the input data when the beam prediction model operation is performed. The reference signal measured by the terminal may include the reference signal in the first reference signal set and/or the reference signal in the second reference signal set. The input of the beam prediction model may be the beam information corresponding to the reference signal in the first reference signal set, the output of the beam prediction model may be the beam information corresponding to the reference signal in the second reference signal set, and the output of the beam prediction model may also be the preferred beam information. It can be understood that the preferred beam information may include one or more of the beam information of the preferred transmit beam, the beam information of the preferred receive beam, and the beam information of the preferred beam pair. The preferred beam pair includes the preferred transmit beam and the preferred receive beam.

For example, the first reference signal set may be set B, and the second reference signal set may be set A. The input of the beam prediction model may be beam information corresponding to a reference signal in set B, such as a L1-RSRP and/or a L1-SINR corresponding to each reference signal in set B. The output of the beam prediction model may include beam information corresponding to a reference signal in set A, such as a L1-RSRP and/or a L1-SINR corresponding to each reference signal in set A.

Alternatively, in some cases, the output of the beam prediction model may further include the preferred beam information, such as preferred K pieces of beam information. The preferred K pieces of beam information may be top K pieces of beam information whose beam quality satisfies a condition, which may be recorded as top K pieces of beam information. In general, the top K pieces of beam information may be top K beam identifiers. The identifier may be an identity (ID) or an index.

For the condition that the beam quality of the top K pieces of beam information satisfies, reference may be made to the related arts, for example, the beam quality satisfies a threshold or the top K beams are selected after sorting is performed according to the beam quality, etc., which are not limited in the present disclosure.

It can be understood that the input sample data can be input data related to set B for the beam prediction model operation.

In some embodiments, the input sample data may include the beam information of the first transmit beam corresponding to the reference signal in the first reference signal set, or the beam information of the first beam pair corresponding to the reference signal in the first reference signal set, where the first beam pair includes the first transmit beam and the first receive beam.

For example, the input sample data may include beam information of a transmit beam in set B, or beam information of a beam pair in set B. It can be understood that the first transmit beam may be the transmit beam in set B, and a beam pair consisting of a receive beam and the transmit beam in set B may be referred to as the first beam pair. That is, the first beam pair includes a receive beam used by the terminal for reference signal measurement and the transmit beam in set B. Alternatively, the first receive beam may include all receive beams used by the terminal for reference signal measurement, or may include part of all receive beams, which is not limited in the present disclosure.

It can be understood that the transmit beam is a beam indicated by the reference signal.

The beam information may be a L1-RSRP and/or a L1-SINR of the beam or the beam pair.

In some embodiments, the input sample data may include the reference signal identifier of the reference signal in the first reference signal set, and the identifier may be an ID or an index.

For example, the input sample data may include a reference signal ID of the reference signal in set B.

In some embodiments, the input sample data may include the first receive beam identifier.

For example, the input sample data may include a first receive (RX) beam ID. It can be understood that the first RX beam ID is used to indicate the first RX beam.

In some embodiments, the input sample data may include the first beam pair identifier.

For example, the input sample data may include a first beam pair ID. The first beam pair ID may include a combined ID of the first RX beam ID and the reference signal ID of the reference signal in set B. That is, the first beam pair ID may indicate the corresponding first beam pair, and the first receive beam and the first transmit beam corresponding to the first beam pair. It can be understood that the transmit beam of the first beam pair may be indicated by the reference signal ID of the reference signal in set B.

Alternatively, in other embodiments, the input sample data may include any two, three or four of the above items. For example, the input sample data may include: the beam information of the first transmit beam corresponding to the reference signal in the first reference signal set, or the beam information of the first beam pair corresponding to the reference signal in the first reference signal set, and the reference signal identifier of the reference signal in the first reference signal set; the reference signal identifier of the reference signal in the first reference signal set and the first receive beam identifier; the beam information of the first transmit beam corresponding to the reference signal in the first reference signal set, or the beam information of the first beam pair corresponding to the reference signal in the first reference signal set, the reference signal identifier of the reference signal in the first reference signal set, and the first beam pair identifier; the beam information of the first transmit beam corresponding to the reference signal in the first reference signal set, or the beam information of the first beam pair corresponding to the reference signal in the first reference signal set, the reference signal identifier of the reference signal in the first reference signal set, the first receive beam identifier, and the first beam pair identifier. For the convenience of description, the present disclosure does not list them one by one here.

In some embodiments, in a case where the first reference signal set and the second reference signal set are different, and the output of the beam prediction model is the beam information corresponding to the second reference signal set, the terminal may collect the input sample data involved above. The first reference signal set and the second reference signal set being different involved in the present disclosure is used to mean that none of reference signals in the first set are the same as those in the second set, that is, the first reference signal set and the second reference signal set do not share any common reference signal.

For example, set B is different from set A, and the output of the beam prediction model is the beam information corresponding to set A, for example, the beam prediction model outputs a L1-RSRP and/or a L1-SINR of each beam or each beam pair in set A.

It can be understood that in the embodiment, set B can be a wide beam and set A can be a narrow beam. Alternatively, in general, the beam prediction model can output L1-RSRPs and/or L1-SINRs of all beams, some beams, all beam pairs or some beam pairs in set A.

In some embodiments, in a case where the first reference signal set is a subset of the second reference signal set, or the first reference signal set is the same as the second reference signal set, and the output of the beam prediction model is the beam information corresponding to the second reference signal set, the terminal can collect the input sample data involved above.

For example, set B is a subset of set A, or set B is equal to set A, and the output of the beam prediction model is the beam information corresponding to set A, for example, the beam prediction model outputs L1-RSRPs and/or L1-SINRs of all beams, some beams, all beam pairs or some beam pairs in set A.

In some embodiments, in a case where the first reference signal set and the second reference signal set are different, and the output of the beam prediction model is the preferred beam information, the terminal may collect the input sample data involved above.

For example, set B is different from set A, and the output of the beam prediction model is the preferred beam information, for example, the beam prediction model outputs top K pieces of transmit beam information, top K pieces of receive beam information and/or top K pieces of beam pair information.

It can be understood that in the embodiment, set B can be a wide beam and set A can be a narrow beam. The preferred beam information can be a preferred transmit beam identifier, a preferred receive beam identifier and/or a preferred beam pair identifier, such as top K transmit beam IDs, top K receive beam IDs and/or top K beam pair IDs.

In some embodiments, in a case where the first reference signal set is a subset of the second reference signal set, or the first reference signal set is the same as the second reference signal set, and the output of the beam prediction model is the preferred beam information, the terminal may collect the input sample data involved above.

For example, set B is a subset of set A, or set B is equal to set A, and the output of the beam prediction model is the preferred beam information, for example, the beam prediction model outputs top K pieces of transmit beam information, top K pieces of receive beam information and/or top K pieces of beam pair information.

In the present disclosure, the sample data collected by the terminal may include a variety of input sample data for the beam prediction model operation, so that when the beam prediction model is operated, the network device can use the sample data reported by the terminal for operation, thereby improving the accuracy of the output result of the beam prediction model.

In the method for collecting the data provided by embodiments of the present disclosure, the sample data may include sample label data. The sample label data is used as a label when the beam prediction model is operated. In response to the first reference signal set, the second reference signal set, and the output of the beam prediction model satisfying a first condition, the sample label data includes at least one of the following parameters: beam information of a second transmit beam corresponding to the reference signal in the second reference signal set, or beam information of a second beam pair corresponding to the reference signal in the second reference signal set, where the second beam pair includes the second transmit beam and a receive beam; a reference signal identifier of the reference signal in the second reference signal set; a second receive beam identifier; or a second beam pair identifier.

In some embodiments, the sample data may further include the sample label data. The sample label data may be used as the label when the beam prediction model is operated. For example, the sample label data may be used as a label output by the beam prediction model when the beam prediction model is trained or monitored.

It can be understood that the sample label data can be a label related to set A for the beam prediction model operation.

In some embodiments, in response to the first reference signal set, the second reference signal set, and the output of the beam prediction model satisfying the first condition, the sample label data may include the beam information of the second transmit beam corresponding to the reference signal in the second reference signal set, or the beam information of the second beam pair corresponding to the reference signal in the second reference signal set, where the second beam pair includes the second transmit beam and the second receive beam.

For example, the sample label data may include beam information of a transmit beam in set A, or beam information of a beam pair in set A. It can be understood that the second transmit beam may be the transmit beam in set A, and a beam pair consisting of the receive beam and the transmit beam in set A may be referred to as the second beam pair. That is, the second beam pair includes the receive beam used by the terminal for the reference signal measurement and the transmit beam in set A. Alternatively, the second receive beam may generally include all receive beams used by the terminal for reference signal measurement. Alternatively, the second receive beam may further include some receive beams among all receive beams.

In some embodiments, in response to the first reference signal set, the second reference signal set, and the output of the beam prediction model satisfying the first condition, the sample label data may include the reference signal identifier of the reference signal in the second reference signal set.

For example, the sample label data may include a reference signal ID of the reference signal in set A.

In some embodiments, in response to the first reference signal set, the second reference signal set, and the output of the beam prediction model satisfying the first condition, the sample label data may include the second receive beam identifier.

For example, the sample label data may include a second RX beam ID. It can be understood that the second RX beam ID is used to indicate the second RX beam.

It can be understood that the first RX beams and the second RX beams may be completely or partially the same, or may be completely different, which is not limited by the present disclosure.

In some embodiments, in response to the first reference signal set, the second reference signal set, and the output of the beam prediction model satisfying the first condition, the sample label data may include the second beam pair identifier.

For example, the sample label data may include a second beam pair ID. The second beam pair ID may include a combined ID of the second RX beam ID and the reference signal ID of the reference signal in set A. That is, the second beam pair ID may indicate the corresponding second beam pair, and the second receive beam and the second transmit beam corresponding to the second beam pair. It can be understood that the transmit beam of the second beam pair may be indicated by the reference signal ID of the reference signal in set A.

Alternatively, in other embodiments, in response to the first reference signal set, the second reference signal set and the output of the beam prediction model satisfying the first condition, the sample label data may include any two, three or four of the above items. For example, the sample label data may include: the beam information of the second transmit beam corresponding to the reference signal in the second reference signal set, or the beam information of the second beam pair corresponding to the reference signal in the second reference signal set, and the reference signal identifier of the reference signal in the second reference signal set; the reference signal identifier of the reference signal in the second reference signal set and the second receive beam identifier; the beam information of the second transmit beam corresponding to the reference signal in the second reference signal set, or the beam information of the second beam pair corresponding to the reference signal in the second reference signal set, the reference signal identifier of the reference signal in the second reference signal set, and the second beam pair identifier; the beam information of the second transmit beam corresponding to the reference signal in the second reference signal set, or the beam information of the second beam pair corresponding to the reference signal in the second reference signal set, the reference signal identifier of the reference signal in the second reference signal set, the second receive beam identifier, and the second beam pair identifier. For the convenience of description, the present disclosure does not list them one by one here.

In the present disclosure, the sample data collected by the terminal may include a variety of labels for the beam prediction model operation, so that when the beam prediction model is operated, the network device can use the sample data reported by the terminal for operation, thereby improving the accuracy of the output result of the beam prediction model.

In the method for collecting the data provided by embodiments of the present disclosure, the first condition includes at least one of: the first reference signal set and the second reference signal set being different, and the output of the beam prediction model being the beam information corresponding to the second reference signal set; or the first reference signal set being a subset of the second reference signal set, or the first reference signal set being the same as the second reference signal set, and the output of the beam prediction model being the beam information corresponding to the second reference signal set.

In some embodiments, the first condition may be that the first reference signal set and the second reference signal set are different, and the output of the beam prediction model is the beam information corresponding to the second reference signal set.

For example, the first condition is that set B and set A are different, and the output of the beam prediction model is the beam information corresponding to set A, for example, the beam prediction model outputs L1-RSRPs and/or L1-SINRs of all beams, some beams, all beam pairs or some beam pairs in set A.

It can be understood that in the embodiment, set B can be a wide beam and set A can be a narrow beam.

In some embodiments, the first condition may be that the first reference signal set is a subset of the second reference signal set, or the first reference signal set is the same as the second reference signal set, and the output of the beam prediction model is the beam information corresponding to the second reference signal set.

For example, the first condition is that set B is a subset of set A, or set B is equal to set A, and the output of the beam prediction model is the beam information corresponding to set A, for example, the beam prediction model outputs L1-RSRPs and/or L1-SINRs of all beams, some beams, all beam pairs or some beam pairs in set A.

In some embodiments, for a case where the first reference signal set is a subset of the second reference signal set, or the first reference signal set is the same as the second reference signal set, and the output of the beam prediction model is the beam information corresponding to the second reference signal set, the input sample data may be included in the sample label data.

It can be understood that since set B is a subset of set A, or set B is equal to set A, the input data related to set B for the beam prediction model operation can be part or all of the data in the label related to set A for the beam prediction model operation. That is, the input sample data can be part of the data in the sample label data, or the input sample data can be exactly the same as the sample label data.

For example, in a case where set B is a subset of set A, the input sample data may be part of the sample label data. For another example, in a case where set B is equal to set A, the input sample data may be completely the same as the sample label data.

In some embodiments, for a case where set B is a subset of set A, the network device may configure which part of the beams or beam pairs in set A is selected as set B. Alternatively, if the network device does not perform the corresponding configuration, when the terminal measures set B, it may randomly select part of the beams or beam pairs from set A as set B. Alternatively, the terminal selects, based on a protocol provision or a preset selection manner, part of the beams or beam pairs from set A as set B, which is not specifically limited in the present disclosure.

In some embodiments, for a case where the first reference signal set is a subset of the second reference signal set, or the first reference signal set is the same as the second reference signal set, and the output of the beam prediction model is the beam information corresponding to the second reference signal set, if the sample data includes the input sample data and the sample label data, the sample label data may not include data that is the same as the input sample data. For example, the sample label data is the remaining data of set A minus set B. Alternatively, in some other examples, the sample data may only include the sample label data, then the sample label data in this case is the data corresponding to set A, and the input sample data can be determined from the sample label data.

It should be understood that the first condition in the present disclosure may further include: the first reference signal set and the second reference signal set being different, and the output of the beam prediction model being the beam information corresponding to the second reference signal set; and the first reference signal set being a subset of the second reference signal set, or the first reference signal set being the same as the second reference signal set, and the output of the beam prediction model being the beam information corresponding to the second reference signal set.

The present disclosure is adapted to a plurality of different reference signal sets and beam prediction models. Accordingly, in such cases, the terminal collects the sample data including various labels for the beam prediction model operation, so that when the beam prediction model is operated, the network device can use the sample data reported by the terminal for operation, thereby improving the accuracy of the output result of the beam prediction model.

In the method for collecting the data provided by embodiments of the present disclosure, the sample data includes the sample label data. The sample label data is used as a label when the beam prediction model is operated. In response to the first reference signal set, the second reference signal set, and the output of the beam prediction model satisfying a second condition, the sample label data includes: a preferred transmit beam identifier or a third beam pair identifier in the second reference signal set, where the third beam pair includes a preferred transmit beam and a preferred receive beam.

In some embodiments, the sample data may further include the sample label data. The sample label data may be used as the label when the beam prediction model is operated. For example, the sample label data may be used as a label output by the beam prediction model when the beam prediction model is trained or monitored.

In some embodiments, in response to the first reference signal set, the second reference signal set, and the output of the beam prediction model satisfying the second condition, the sample label data may include the preferred transmit beam identifier or the third beam pair identifier in the second reference signal set, where the third beam pair includes the preferred transmit beam and the preferred receive beam.

For example, the sample label data may include top K transmit beam identifiers and/or top K beam pair identifiers in set A. The top K beam pairs may include top K transmit beams and top K preferred receive beams.

It can be understood that, in the embodiment, set B may be a wide beam, and set A may be a narrow beam. The top K transmit beam identifiers may be top K transmit beam IDs, and the top K beam pair identifiers may be top K beam pair IDs.

For example, the preferred transmit beam included in the third beam pair may be the same as the preferred transmit beam in the second reference signal set.

For another example, preferred transmit beams included in the third beam pair may not be completely the same as or different from preferred transmit beams in the second reference signal set. It can be understood that the second reference signal set is set A, and the preferred transmit beam in the second reference signal set is the preferred transmit beam in set A output by the beam prediction model; and the third beam pair is the preferred beam pair in set A output by the beam prediction model. Since the beam pair is composed of the receive beam and the transmit beam, it can be contemplated that some transmit beams may not meet a condition corresponding to the preferred transmit beam, but if they form beam pairs with some receive beams, they may meet a condition corresponding to the preferred beam pair. Some transmit beams meet the condition corresponding to the preferred transmit beam, but if they form beam pairs with some receive beams, they may not meet the condition corresponding to the preferred beam pair. Therefore, the preferred transmit beams included in the preferred beam pairs in set A may be partially the same as or completely different from the preferred transmit beams in set A.

In the present disclosure, the sample data collected by the terminal may include a variety of labels for the beam prediction model operation, so that when the beam prediction model is operated, the network device can use the sample data reported by the terminal for operation, thereby improving the accuracy of the output result of the beam prediction model.

In the method for collecting the data provided by embodiments of the present disclosure, the second condition includes at least one of: the first reference signal set and the second reference signal set being different, and the output of the beam prediction model being the preferred beam information; or the first reference signal set being a subset of the second reference signal set, or the first reference signal set being the same as the second reference signal set, and the output of the beam prediction model being the preferred beam information.

In some embodiments, the second condition may be that the first reference signal set and the second reference signal set are different, and the output of the beam prediction model is the preferred beam information.

For example, the second condition is that set B and set A are different, and the output of the beam prediction model is the preferred beam information, for example, the beam prediction model outputs top K pieces of transmit beam information, top K pieces of receive beam information and/or top K pieces of beam pair information.

It can be understood that in the embodiment, set B can be a wide beam and set A can be a narrow beam. The preferred beam information can be a preferred transmit beam identifier, a preferred receive beam identifier and/or a preferred beam pair identifier, such as top K transmit beam IDs, top K receive beam IDs and/or top K beam pair IDs.

The preferred beam information output by the beam prediction model may be one or more of the preferred transmit beam in the second reference signal set, the preferred receive beam in the second reference signal set, and the preferred beam pair in the second reference signal set output by the beam prediction model. The preferred beam pair in the second reference signal set includes the preferred transmit beam and the preferred receive beam. It can be understood that the preferred transmit beams included in the preferred beam pairs may be the same as, partially the same as, or completely different from the preferred transmit beams in the second reference signal set. The preferred receive beams included in the preferred beam pairs may be the same as, partially the same as, or completely different from the preferred receive beams in the second reference signal set.

A beam pair is composed of a receive beam and a transmit beam. For example, some transmit beams may not meet a condition corresponding to the preferred transmit beam, but if they form beam pairs with some receive beams, they may meet a condition corresponding to the preferred beam pair. Some transmit beams meet the condition corresponding to the preferred transmit beam, but if they form beam pairs with some receive beams, they may not meet the condition corresponding to the preferred beam pair. For another example, some receive beams may not meet a condition corresponding to the preferred receive beam, but when they form beam pairs with some transmit beams, they may meet the condition corresponding to the preferred beam pair. Some receive beams meet the condition corresponding to the preferred receive beam, but when they form beam pairs with some transmit beams, they may not meet the condition corresponding to the preferred beam pair.

Therefore, the preferred receive beams included in the preferred beam pairs may be the same as, partially the same as, or completely different from the preferred receive beams in the second reference signal set.

In some embodiments, the second condition may be that the first reference signal set is a subset of the second reference signal set, or the first reference signal set is the same as the second reference signal set, and the output of the beam prediction model is the preferred beam information.

For example, the second condition is that set B is a subset of set A, or set B is equal to set A, and the output of the beam prediction model is the preferred beam information, for example, the beam prediction model outputs top K pieces of transmit beam information, top K pieces of receive beam information and/or top K pieces of beam pair information.

It can be understood that the preferred beam information can be a preferred transmit beam identifier, a preferred receive beam identifier and/or a preferred beam pair identifier, such as top K transmit beam IDs, top K receive beam IDs and/or top K beam pair IDs.

It should be understood that the third condition in the present disclosure may further include: the first reference signal set and the second reference signal set being different, and the output of the beam prediction model being the preferred beam information; and the first reference signal set being a subset of the second reference signal set, or the first reference signal set being the same as the second reference signal set, and the output of the beam prediction model being the preferred beam information.

The present disclosure is adapted to a plurality of different reference signal sets and beam prediction models. Accordingly, in such cases, the terminal collects the sample data including various labels for the beam prediction model operation, so that when the beam prediction model is operated, the network device can use the sample data reported by the terminal for operation, thereby improving the accuracy of the output result of the beam prediction model.

In the method for collecting the data provided by embodiments of the present disclosure, the sample data includes at least one of the following parameters: the amount of sample data; a scene and/or a sample parameter corresponding to the sample data; a beam prediction model identifier and/or a beam prediction model function; or a timestamp corresponding to the sample data.

In some embodiments, the sample data may include the amount of sample data.

It can be understood that the amount of sample data is used to identify how much sample data the terminal reports to the network device.

In some embodiments, the sample data may include the scene and/or the sample parameter corresponding to the sample data.

For example, the scene corresponding to the sample data may refer to a scene in which the terminal that measures the sample data is located, such as an urban macro (Uma) scene, an urban micro (Umi) scene, an indoor scene, and the like.

For another example, the sample parameter corresponding to the sample data may be the number of Rx beams of the terminal, a beam width, a beam angle, a moving speed of the terminal, an antenna configuration of the terminal, the number of antenna panels, and other parameters

Alternatively, the scene may include more possible scenes according to actual conditions, and the sample parameter may include more possible parameters according to actual conditions, which are not limited in the present disclosure.

In some embodiments, the sample data may include the beam prediction model identifier and/or the beam prediction model function.

The beam prediction model identifier can be used to uniquely indicate which AI model is operated. The beam prediction model function can indicate what the AI model is used for. For example, it indicates that the AI model is used for beam prediction, for location prediction, for channel state information (CSI) compression, for terminal mobility management, and so on.

In some embodiments, the sample data may include the timestamp corresponding to the sample data.

For example, the timestamp corresponding to the sample data may be indicated explicitly or implicitly. Explicit indication means indicating the timestamp corresponding to each piece of sample data. Implicit indication means that time period lengths corresponding to individual pieces of sample data are the same, and each piece of sample data is recorded, stored, transmitted, etc. in chronological order. For example, each piece of sample data is sequentially arranged in chronological order.

It should be understood that the sample data in the present disclosure may further include any two, three or four of the above items. For example, the sample data may further include: the amount of sample data, and the timestamp corresponding to the sample data; the scene and/or the sample parameter corresponding to the sample data, and the timestamp corresponding to the sample data; the amount of sample data, the scene and/or the sample parameter corresponding to the sample data, and the timestamp corresponding to the sample data; the amount of sample data, the scene and/or the sample parameter corresponding to the sample data, and the timestamp corresponding to the sample data; the amount of sample data, the scene and/or the sample parameter corresponding to the sample data, the beam prediction model identifier and/or the beam prediction model function, and the timestamp corresponding to the sample data. For the convenience of description, the present disclosure does not list them one by one here.

In some embodiments, the sample data may include the input sample data and/or the sample label data, and may further include one or more of the amount of sample data, the scene and/or the sample parameter corresponding to the sample data, the beam prediction model identifier and/or the beam prediction model function, and the timestamp corresponding to the sample data, which is not limited by the present disclosure.

The present disclosure provides a variety of information included in the sample data, so that when the beam prediction model is operated, the network device can use the sample data reported by the terminal for operation, thereby improving the accuracy of the output result of the beam prediction model.

In the method for collecting the data provided by embodiments of the present disclosure, the sample data is used to operate the beam prediction model. The data collection indication information at least includes measurement configuration information. The measurement configuration information may include at least one of: at least one reference signal set; a data collection start time; or a data collection end time.

In some embodiments, the sample data obtained by the terminal measuring the reference signal can be used to perform the corresponding operation on the beam prediction model. The beam prediction model can be an AI model for beam prediction. The data collection indication information received by the terminal shall include at least the measurement configuration information, and the measurement configuration information may include a parameter indicating the terminal to perform measurement. The terminal can measure the reference signal based on the measurement configuration information to obtain the sample data.

For example, the measurement configuration information includes some parameters indicating the terminal to perform measurement, such as indicating when to perform measurement by the terminal, which reference signals the terminal measures, etc. The terminal can perform corresponding measurements on the reference signals based on these parameters and obtain corresponding sample data.

In some embodiments, the measurement configuration information may include the at least one reference signal set.

For example, the network device informs, through the measurement configuration information, the terminal which reference signal sets are configured. When a plurality of reference signal sets are configured, a relationship between respective reference signal sets also needs to be indicated. For example, two reference signal sets, that is, set B and set A, are configured, and the measurement configuration information also needs to indicate a beam relationship between set B and set A. That is, it indicates that set B is a subset of set A, or set B and set A are the same, or set B and set A are different. If set B is the subset of set A, it can indicate which reference signals in set A are included in set B. If set B and set A are different, it can also indicate beams corresponding to which reference signals in set A may be covered by a beam corresponding to one reference signal in set B.

In some embodiments, the measurement configuration information may include the data collection start time, and the data collection start time indicates a time when the network device sends the reference signal.

For example, the data collection start time may be implicitly indicated, for example, the data collection start time is indicated by a time when the network device sends the reference signal. In another example, the data collection start time may be explicitly indicated, that is, the start time of data collection by the terminal is directly indicated.

In some embodiments, the measurement configuration information may include the data collection end time, and the data collection end time indicates a time when the terminal ends the measurement.

For example, the data collection end time may be implicitly indicated, for example, the data collection end time is indicated by a time when the network device stops sending the reference signal. In another example, the data collection end time may be explicitly indicated, that is, the end time of data collection by the terminal is directly indicated.

It should be understood that the measurement configuration information in the present disclosure may further include any two or three of the above items, and the measurement configuration information may further include: the at least one reference signal set, and the data collection start time; the at least one reference signal set, and the data collection end time, the data collection start time, and the data collection end time; the at least one reference signal set, the data collection start time, and the data collection end time.

The present disclosure provides a variety of information included in the measurement configuration information, which facilitates the terminal to collect the corresponding sample data, so that when the beam prediction model is operated, the sample data of the terminal can be used for operation, thereby improving the accuracy of the output result of the beam prediction model.

In the method for collecting the data provided by embodiments of the present disclosure, FIG. 3 shows a flowchart of another method for collecting data according to an embodiment of the present disclosure. As shown in FIG. 3, the beam prediction model is operated on the terminal. The method may further include the following step:

in step S21, a data collection request is sent.

In some embodiments, the beam prediction model can be operated on the terminal. In this scene, the terminal can send the data collection request to the network device. The data collection request is configured to indicate to the network device to configure the data collection indication information. That is, the data collection request is configured to indicate to the network device to configure the measurement configuration information.

For example, the terminal may send the data collection request to the network device, and the terminal receives the measurement configuration information sent by the network device. The measurement configuration information is configured by the network device based on the data collection request and sent to the terminal.

The present disclosure can be applicable to a scene where the beam prediction model is operated on the terminal. The measurement configuration information is used to indicate to the terminal to collect the corresponding sample data, so that when the beam prediction model is operated, the terminal can use the sample data of the terminal for operation, thereby improving the accuracy of the output result of the beam prediction model.

In the method for collecting the data provided by embodiments of the present disclosure, the data collection request may include at least one of the following parameters: the amount of sample data; or reference signal set configuration information.

In some embodiments, the data collection request may include the amount of sample data.

It can be understood that the amount of sample data is used to inform the network device of the amount of sample data used for the beam prediction model operation.

In some embodiments, the data collection request may include the reference signal set configuration information.

It can be understood that the reference signal set configuration information informs the network device whether the terminal uses one reference signal set or two reference signal sets to collect the sample data.

For example, one reference signal set may correspond to a scene where set B is the same as set A, or set B is a subset of set A. Two reference signal sets may correspond to a scene where set B is a wide beam and set A is a narrow beam, or set B is a subset of set A. In other words, the reference signal set configuration information may indicate the relationship between set B and set A.

The present disclosure provides a variety of information included in the data collection request, which facilitates the network device to configure and send the corresponding reference signal in a scene where the beam prediction model is operated on the terminal. Accordingly, the terminal can collect the corresponding sample data, so that when the beam prediction model is operated, the terminal can use the sample data of the terminal for operation, thereby improving the accuracy of the output result of the beam prediction model.

In the method for collecting the data provided by embodiments of the present disclosure, the data collection indication information further includes report configuration information. The report configuration information is configured to indicate at least one of the following reporting manners: periodic reporting; aperiodic reporting; or radio resource control (RRC) signaling or uplink control information (UCI)-based reporting.

In some embodiments, the data collection indication information received by the terminal may further include the report configuration information. The report configuration information may include a parameter indicating the terminal to report the sample data to the network device, such as indicating a reporting manner in which the terminal reports the sample data. The terminal may report the sample data based on the report configuration information.

In some embodiments, the report configuration information is configured to indicate that the measurement result is reported in the periodic reporting manner.

In some embodiments, the report configuration information is configured to indicate that the measurement result is reported in the aperiodic reporting manner.

In some embodiments, the report configuration information is configured to indicate that the measurement result is reported in the RRC signaling or UCI-based reporting manner.

It should be understood that the measurement configuration information in the present disclosure may further include any two or three of the above items. For example, the report configuration information is configured to indicate: the periodic reporting, and the aperiodic reporting; the periodic reporting, and the RRC signaling or UCI-based reporting; the aperiodic reporting, and the RRC signaling or UCI-based reporting; and the periodic reporting, the aperiodic reporting, and the RRC signaling or UCI-based reporting.

The present disclosure provides a variety of reporting manners, which can be applied to different reporting scenes, where when the beam prediction model is operated, the network device can use the sample data reported by the terminal for operation, thereby improving the accuracy of the output result of the beam prediction model.

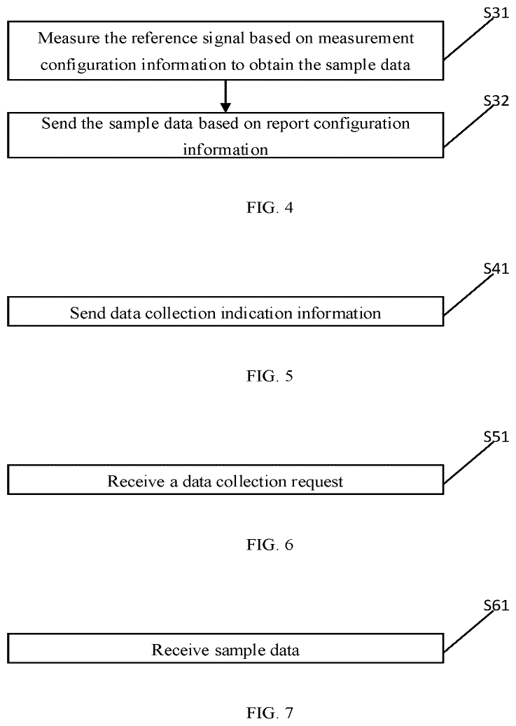

In the method for collecting the data provided by embodiments of the present disclosure, FIG. 4 shows a flowchart of yet another method for collecting data according to an embodiment of the present disclosure. As shown in FIG. 4, the beam prediction model is operated on the network device. Measuring the reference signal based on the data collection indication information to obtain the sample data in the S12 may include the following step:

In step S31, the reference signal is measured based on the measurement configuration information to obtain the sample data.

In some embodiments, the beam prediction model can be operated on the network device. In this scene, the terminal may perform the corresponding measurement on the reference signal based on the measurement configuration information and obtain the corresponding sample data.

The method may further include the following step:

In step S32, the sample data is sent based on the report configuration information.

In some embodiments, the terminal may send, based on the report configuration information, the sample data obtained in the S31 to the network device.

For example, the report configuration information may include a parameter indicating the terminal to report the sample data to the network device, such as indicating a manner in which the terminal reports the sample data. The terminal may send the sample data to the network device based on the reporting manner indicated by the report configuration information, so that the network device operates the beam prediction model using the sample data sent by the terminal.

The present disclosure can be applicable to a scene where the beam prediction model is operated on the network device. The terminal is indicated, through the measurement configuration information and the report configuration information, to collect the corresponding sample data and report it to the network device, so that when the beam prediction model is operated, the network device can use the sample data reported by the terminal for operation, thereby improving the accuracy of the output result of the beam prediction model.

In the method for collecting the data provided by embodiments of the present disclosure, in response to the report configuration information being configured to indicate the periodic reporting, sending the sample data in the S32 includes: sending one or more pieces of sample data.

In some embodiments, in response to the report configuration information being configured to indicate the periodic reporting, the one or more pieces of sample data may be sent. That is, the sample data sent by the terminal to the network device may be the one or more pieces of sample data. In other words, the terminal periodically reports the one or more pieces of sample data.

It can be understood that the amount of sample data in the sample data reported by the terminal each time mainly depends on the amount of sample data available to the terminal in the corresponding reporting period.

The present disclosure is applicable to a case where the measurement result is reported periodically, so that when the beam prediction model is operated, the network device can use the sample data reported by the terminal for operation, thereby improving the accuracy of the output result of the beam prediction model.

In the method for collecting the data provided by embodiments of the present disclosure, in response to the report configuration information being configured to indicate the aperiodic reporting, the sample data at least includes the amount of sample data.

In some embodiments, in response to the report configuration information being configured to indicate the aperiodic reporting, the sample data should include at least the amount of sample data.

It can be understood that since the terminal reports the sample data aperiodically, the amount of sample data in each reported sample data may be different. Therefore, each time the terminal reports the sample data, information indicating the amount of sample data should be included, that is, it is necessary to inform how much sample data is reported.

The present disclosure is applicable to a case where the measurement result is reported aperiodically, so that when the beam prediction model is operated, the network device can use the sample data reported by the terminal for operation, thereby improving the accuracy of the output result of the beam prediction model.

In the method for collecting the data provided by embodiments of the present disclosure, in response to the report configuration information being configured to indicate the RRC signaling or UCI-based reporting, sending the sample data in the S32 includes: sending the sample data through a physical uplink shared channel (PUSCH) or a physical uplink control channel (PUCCH).

In some embodiments, in response to the report configuration information being configured to indicate the RRC signaling or UCI-based reporting, the terminal may send the sample data to the network device through the PUSCH or the PUCCH, and the sample data is carried on the RRC signaling or the UCI.

The present disclosure is applicable to a case where the measurement result is reported based on the RRC signaling or the UCI, so that when the beam prediction model is operated, the network device can use the sample data reported by the terminal for operation, thereby improving the accuracy of the output result of the beam prediction model.

In the method for collecting the data provided by embodiments of the present disclosure, operating the beam prediction model includes at least one of: training the beam prediction model; monitoring the beam prediction model; or performing deduction based on the beam prediction model.

In some embodiments, operating the beam prediction model may be training the beam prediction model.

In some embodiments, operating the beam prediction model may be monitoring the beam prediction model.

In some embodiments, operating the beam prediction model may be performing the deduction based on the beam prediction model.

It should be understood that operating the beam prediction model in the present disclosure may further include: training the beam prediction model and monitoring the beam prediction model; training the beam prediction model and performing the deduction based on the beam prediction model; monitoring the beam prediction model and performing the deduction based on the beam prediction model; training the beam prediction model, monitoring the beam prediction model and performing the deduction based on the beam prediction model.

The present disclosure provides a variety of scenes for operating the beam prediction model, so that in different scenes, when the beam prediction model is operated, the sample data of the terminal can be used for operation, thereby improving the accuracy of the output result of the beam prediction model.

Based on the same concept, the present disclosure further provides a method for collecting data, which is performed on a network device.

FIG. 5 shows a flowchart of still another method for collecting data according to an embodiment of the present disclosure. As shown in FIG. 5, the method is applied to a network device and may include the following step:

in step S41, data collection indication information is sent.

In some embodiments, the network device may send the data collection indication information to the terminal. It can be understood that the data collection indication information may be used to indicate to the terminal to collect sample data, such as when to measure the reference signal, which reference signals to measure, how much data to collect for the beam prediction model operation, etc. The present disclosure does not limit the content indicated by the data collection indication information. Therefore, the terminal measures the reference signal and obtains the sample data.

In some embodiments, the reference signal may be a CSI-RS, a DMRS, a SSB, etc., which is not limited in the present disclosure.

In some embodiments, the network device may send the reference signal to the terminal, and the reference signal may be, for example, a reference signal in one or more reference signal sets.

In the present disclosure, the data collection indication information indicates that the terminal should collect the corresponding sample data, so that when a beam prediction model is operated, the sample data collected by the terminal can be used for operation, thereby improving accuracy of an output result of the beam prediction model.

The present disclosure can be applicable to a scene where the beam prediction model is operated on the network device. The terminal is indicated, through the measurement configuration information and the report configuration information, to collect the corresponding sample data and report it to the network device, so that when the beam prediction model is operated, the network device can use the sample data reported by the terminal for operation, thereby improving the accuracy of the output result of the beam prediction model.

In the method for collecting the data provided by embodiments of the present disclosure, the sample data may include input sample data. The input sample data is used as an input when the beam prediction model is operated. The reference signal may include a reference signal in a first reference signal set and/or a second reference signal set, an input of the beam prediction model is beam information corresponding to the reference signal in the first reference signal set, and an output of the beam prediction model is beam information or preferred beam information corresponding to the reference signal in the second reference signal set. The input sample data may include at least one of the following parameters: beam information of a first transmit beam corresponding to the reference signal in the first reference signal set, or beam information of a first beam pair corresponding to the reference signal in the first reference signal set, where the first beam pair includes the first transmit beam and a first receive beam; a reference signal identifier of the reference signal in the first reference signal set; a first receive beam identifier; or a first beam pair identifier.

In some embodiments, the sample data may include the input sample data. The input sample data may be used as the input data when the beam prediction model operation is performed. The reference signal measured by the terminal may include the reference signal in the first reference signal set and/or the reference signal in the second reference signal set. The input of the beam prediction model may be the beam information corresponding to the reference signal in the first reference signal set, the output of the beam prediction model may be the beam information corresponding to the reference signal in the second reference signal set, and the output of the beam prediction model may also be the preferred beam information. It can be understood that the preferred beam information may include one or more of the beam information of the preferred transmit beam, the beam information of the preferred receive beam, and the beam information of the preferred beam pair. The preferred beam pair includes the preferred transmit beam and the preferred receive beam.

For example, the first reference signal set may be set B, and the second reference signal set may be set A. The input of the beam prediction model may be beam information corresponding to a reference signal in set B, such as a L1-RSRP and/or a L1-SINR corresponding to each reference signal in set B. The output of the beam prediction model may include beam information corresponding to a reference signal in set A, such as a L1-RSRP and/or a L1-SINR corresponding to each reference signal in set A.

Alternatively, in some cases, the output of the beam prediction model may further include the preferred beam information, such as preferred K pieces of beam information. The preferred K pieces of beam information may be top K pieces of beam information whose beam quality satisfies a condition, which may be recorded as top K pieces of beam information. In general, the top K pieces of beam information may be top K beam identifiers. The identifier may be an identity (ID) or an index.

For the condition that the beam quality of the top K pieces of beam information satisfies, reference may be made to the related arts, for example, the beam quality satisfies a threshold or the top K beams are selected after sorting is performed according to the beam quality, etc., which are not limited in the present disclosure.

It can be understood that the input sample data can be input data related to set B for the beam prediction model operation.

In some embodiments, the input sample data may include the beam information of the first transmit beam corresponding to the reference signal in the first reference signal set, or the beam information of the first beam pair corresponding to the reference signal in the first reference signal set, where the first beam pair includes the first transmit beam and the first receive beam.

For example, the input sample data may include beam information of a transmit beam in set B, or beam information of a beam pair in set B. It can be understood that the first transmit beam may be the transmit beam in set B, and a beam pair consisting of a receive beam and the transmit beam in set B may be referred to as the first beam pair. That is, the first beam pair includes a receive beam used by the terminal for reference signal measurement and the transmit beam in set B. Alternatively, the first receive beam may include all receive beams used by the terminal for reference signal measurement, or may include part of all receive beams, which is not limited in the present disclosure.

It can be understood that the transmit beam is a beam indicated by the reference signal.

The beam information may be a L1-RSRP and/or a L1-SINR of the beam or the beam pair.

In some embodiments, the input sample data may include the reference signal identifier of the reference signal in the first reference signal set, and the identifier may be an ID or an index.

For example, the input sample data may include a reference signal ID of the reference signal in set B.

In some embodiments, the input sample data may include the first receive beam identifier.

For example, the input sample data may include a first receive (RX) beam ID. It can be understood that the first RX beam ID is used to indicate the first RX beam.

In some embodiments, the input sample data may include the first beam pair identifier.

For example, the input sample data may include a first beam pair ID. The first beam pair ID may include a combined ID of the first RX beam ID and the reference signal ID of the reference signal in set B. That is, the first beam pair ID may indicate the corresponding first beam pair, and the first receive beam and the first transmit beam corresponding to the first beam pair. It can be understood that the transmit beam of the first beam pair may be indicated by the reference signal ID of the reference signal in set B.

Alternatively, in other embodiments, the input sample data may include any two, three or four of the above items. For example, the input sample data may include: the beam information of the first transmit beam corresponding to the reference signal in the first reference signal set, or the beam information of the first beam pair corresponding to the reference signal in the first reference signal set, and the reference signal identifier of the reference signal in the first reference signal set; the reference signal identifier of the reference signal in the first reference signal set and the first receive beam identifier; the beam information of the first transmit beam corresponding to the reference signal in the first reference signal set, or the beam information of the first beam pair corresponding to the reference signal in the first reference signal set, the reference signal identifier of the reference signal in the first reference signal set, and the first beam pair identifier; the beam information of the first transmit beam corresponding to the reference signal in the first reference signal set, or the beam information of the first beam pair corresponding to the reference signal in the first reference signal set, the reference signal identifier of the reference signal in the first reference signal set, the first receive beam identifier, and the first beam pair identifier. For the convenience of description, the present disclosure does not list them one by one here.

In some embodiments, in a case where the first reference signal set and the second reference signal set are different, and the output of the beam prediction model is the beam information corresponding to the second reference signal set, the terminal may collect the input sample data involved above. The first reference signal set and the second reference signal set being different involved in the present disclosure is used to mean that none of reference signals in the first set are the same as those in the second set, that is, the first reference signal set and the second reference signal set do not share any common reference signal.

For example, set B is different from set A, and the output of the beam prediction model is the beam information corresponding to set A, for example, the beam prediction model outputs a L1-RSRP and/or a L1-SINR of each beam or each beam pair in set A.

It can be understood that in the embodiment, set B can be a wide beam and set A can be a narrow beam. Alternatively, in general, the beam prediction model can output L1-RSRPs and/or L1-SINRs of all beams, some beams, all beam pairs or some beam pairs in set A.

In some embodiments, in a case where the first reference signal set is a subset of the second reference signal set, or the first reference signal set is the same as the second reference signal set, and the output of the beam prediction model is the beam information corresponding to the second reference signal set, the terminal can collect the input sample data involved above.

For example, set B is a subset of set A, or set B is equal to set A, and the output of the beam prediction model is the beam information corresponding to set A, for example, the beam prediction model outputs L1-RSRPs and/or L1-SINRs of all beams, some beams, all beam pairs or some beam pairs in set A.

In some embodiments, in a case where the first reference signal set and the second reference signal set are different, and the output of the beam prediction model is the preferred beam information, the terminal may collect the input sample data involved above.

For example, set B is different from set A, and the output of the beam prediction model is the preferred beam information, for example, the beam prediction model outputs top K pieces of transmit beam information, top K pieces of receive beam information and/or top K pieces of beam pair information.

It can be understood that in the embodiment, set B can be a wide beam and set A can be a narrow beam. The preferred beam information can be a preferred transmit beam identifier, a preferred receive beam identifier and/or a preferred beam pair identifier, such as top K transmit beam IDs, top K receive beam IDs and/or top K beam pair IDs.

In some embodiments, in a case where the first reference signal set is a subset of the second reference signal set, or the first reference signal set is the same as the second reference signal set, and the output of the beam prediction model is the preferred beam information, the terminal may collect the input sample data involved above.

For example, set B is a subset of set A, or set B is equal to set A, and the output of the beam prediction model is the preferred beam information, for example, the beam prediction model outputs top K pieces of transmit beam information, top K pieces of receive beam information and/or top K pieces of beam pair information.

In the present disclosure, the sample data collected by the terminal may include a variety of input sample data for the beam prediction model operation, so that when the beam prediction model is operated, the network device can use the sample data reported by the terminal for operation, thereby improving the accuracy of the output result of the beam prediction model.

In the method for collecting the data provided by embodiments of the present disclosure, the sample data may include sample label data. The sample label data is used as a label when the beam prediction model is operated. In response to the first reference signal set, the second reference signal set, and the output of the beam prediction model satisfying a first condition, the sample label data includes at least one of the following parameters: beam information of a second transmit beam corresponding to the reference signal in the second reference signal set, or beam information of a second beam pair corresponding to the reference signal in the second reference signal set, where the second beam pair includes the second transmit beam and a receive beam, a reference signal identifier of the reference signal in the second reference signal set; a second receive beam identifier; or a second beam pair identifier.

In some embodiments, the sample data may further include the sample label data. The sample label data may be used as the label when the beam prediction model is operated. For example, the sample label data may be used as a label output by the beam prediction model when the beam prediction model is trained or monitored.

It can be understood that the sample label data can be a label related to set A for the beam prediction model operation.

In some embodiments, in response to the first reference signal set, the second reference signal set, and the output of the beam prediction model satisfying the first condition, the sample label data may include the beam information of the second transmit beam corresponding to the reference signal in the second reference signal set, or the beam information of the second beam pair corresponding to the reference signal in the second reference signal set, where the second beam pair includes the second transmit beam and the second receive beam.

For example, the sample label data may include beam information of a transmit beam in set A, or beam information of a beam pair in set A. It can be understood that the second transmit beam may be the transmit beam in set A, and a beam pair consisting of the receive beam and the transmit beam in set A may be referred to as the second beam pair. That is, the second beam pair includes the receive beam used by the terminal for the reference signal measurement and the transmit beam in set A. Alternatively, the second receive beam may generally include all receive beams used by the terminal for reference signal measurement. Alternatively, the second receive beam may further include some receive beams among all receive beams.

In some embodiments, in response to the first reference signal set, the second reference signal set, and the output of the beam prediction model satisfying the first condition, the sample label data may include the reference signal identifier of the reference signal in the second reference signal set.

For example, the sample label data may include a reference signal ID of the reference signal in set A.

In some embodiments, in response to the first reference signal set, the second reference signal set, and the output of the beam prediction model satisfying the first condition, the sample label data may include the second receive beam identifier.

For example, the sample label data may include a second RX beam ID. It can be understood that the second RX beam ID is used to indicate the second RX beam.

It can be understood that the first RX beams and the second RX beams may be completely or partially the same, or may be completely different, which is not limited by the present disclosure.

In some embodiments, in response to the first reference signal set, the second reference signal set, and the output of the beam prediction model satisfying the first condition, the sample label data may include the second beam pair identifier.

For example, the sample label data may include a second beam pair ID. The second beam pair ID may include a combined ID of the second RX beam ID and the reference signal ID of the reference signal in set A. That is, the second beam pair ID may indicate the corresponding second beam pair, and the second receive beam and the second transmit beam corresponding to the second beam pair. It can be understood that the transmit beam of the second beam pair may be indicated by the reference signal ID of the reference signal in set A.

Alternatively, in other embodiments, in response to the first reference signal set, the second reference signal set and the output of the beam prediction model satisfying the first condition, the sample label data may include any two, three or four of the above items. For example, the sample label data may include: the beam information of the second transmit beam corresponding to the reference signal in the second reference signal set, or the beam information of the second beam pair corresponding to the reference signal in the second reference signal set, and the reference signal identifier of the reference signal in the second reference signal set; the reference signal identifier of the reference signal in the second reference signal set and the second receive beam identifier; the beam information of the second transmit beam corresponding to the reference signal in the second reference signal set, or the beam information of the second beam pair corresponding to the reference signal in the second reference signal set, the reference signal identifier of the reference signal in the second reference signal set, and the second beam pair identifier; the beam information of the second transmit beam corresponding to the reference signal in the second reference signal set, or the beam information of the second beam pair corresponding to the reference signal in the second reference signal set, the reference signal identifier of the reference signal in the second reference signal set, the second receive beam identifier, and the second beam pair identifier. For the convenience of description, the present disclosure does not list them one by one here.

In the present disclosure, the sample data collected by the terminal may include a variety of labels for the beam prediction model operation, so that when the beam prediction model is operated, the network device can use the sample data reported by the terminal for operation, thereby improving the accuracy of the output result of the beam prediction model.

In the method for collecting the data provided by embodiments of the present disclosure, the first condition includes at least one of: the first reference signal set and the second reference signal set being different, and the output of the beam prediction model being the beam information corresponding to the second reference signal set; or the first reference signal set being a subset of the second reference signal set, or the first reference signal set being the same as the second reference signal set, and the output of the beam prediction model being the beam information corresponding to the second reference signal set.

In some embodiments, the first condition may be that the first reference signal set and the second reference signal set are different, and the output of the beam prediction model is the beam information corresponding to the second reference signal set.

For example, the first condition is that set B and set A are different, and the output of the beam prediction model is the beam information corresponding to set A, for example, the beam prediction model outputs L1-RSRPs and/or L1-SINRs of all beams, some beams, all beam pairs or some beam pairs in set A.

It can be understood that in the embodiment, set B can be a wide beam and set A can be a narrow beam.

In some embodiments, the first condition may be that the first reference signal set is a subset of the second reference signal set, or the first reference signal set is the same as the second reference signal set, and the output of the beam prediction model is the beam information corresponding to the second reference signal set.

For example, the first condition is that set B is a subset of set A, or set B is equal to set A, and the output of the beam prediction model is the beam information corresponding to set A, for example, the beam prediction model outputs L1-RSRPs and/or L1-SINRs of all beams, some beams, all beam pairs or some beam pairs in set A.

In some embodiments, for a case where the first reference signal set is a subset of the second reference signal set, or the first reference signal set is the same as the second reference signal set, and the output of the beam prediction model is the beam information corresponding to the second reference signal set, the input sample data may be included in the sample label data.

It can be understood that since set B is a subset of set A, or set B is equal to set A, the input data related to set B for the beam prediction model operation can be part or all of the data in the label related to set A for the beam prediction model operation. That is, the input sample data can be part of the data in the sample label data, or the input sample data can be exactly the same as the sample label data.

For example, in a case where set B is a subset of set A, the input sample data may be part of the sample label data. For another example, in a case where set B is equal to set A, the input sample data may be completely the same as the sample label data.

In some embodiments, for a case where set B is a subset of set A, the network device may configure which part of the beams or beam pairs in set A is selected as set B. Alternatively, if the network device does not perform the corresponding configuration, when the terminal measures set B, it may randomly select part of the beams or beam pairs from set A as set B. Alternatively, the terminal selects, based on a protocol provision or a preset selection manner, part of the beams or beam pairs from set A as set B, which is not specifically limited in the present disclosure.

In some embodiments, for a case where the first reference signal set is a subset of the second reference signal set, or the first reference signal set is the same as the second reference signal set, and the output of the beam prediction model is the beam information corresponding to the second reference signal set, if the sample data includes the input sample data and the sample label data, the sample label data may not include data that is the same as the input sample data. For example, the sample label data is the remaining data of set A minus set B. Alternatively, in some other examples, the sample data may only include the sample label data, then the sample label data in this case is the data corresponding to set A, and the input sample data can be determined from the sample label data.

It should be understood that the first condition in the present disclosure may further include: the first reference signal set and the second reference signal set being different, and the output of the beam prediction model being the beam information corresponding to the second reference signal set; and the first reference signal set being a subset of the second reference signal set, or the first reference signal set being the same as the second reference signal set, and the output of the beam prediction model being the beam information corresponding to the second reference signal set.

The present disclosure is adapted to a plurality of different reference signal sets and beam prediction models. Accordingly, in such cases, the terminal collects the sample data including various labels for the beam prediction model operation, so that when the beam prediction model is operated, the network device can use the sample data reported by the terminal for operation, thereby improving the accuracy of the output result of the beam prediction model.

In the method for collecting the data provided by embodiments of the present disclosure, the sample data includes the sample label data. The sample label data is used as a label when the beam prediction model is operated. In response to the first reference signal set, the second reference signal set, and the output of the beam prediction model satisfying a second condition, the sample label data includes: a preferred transmit beam identifier or a third beam pair identifier in the second reference signal set, where the third beam pair includes a preferred transmit beam and a preferred receive beam.

In some embodiments, the sample data may further include the sample label data. The sample label data may be used as the label when the beam prediction model is operated. For example, the sample label data may be used as a label output by the beam prediction model when the beam prediction model is trained or monitored.

In some embodiments, in response to the first reference signal set, the second reference signal set, and the output of the beam prediction model satisfying the second condition, the sample label data may include the preferred transmit beam identifier or the third beam pair identifier in the second reference signal set, where the third beam pair includes the preferred transmit beam and the preferred receive beam.

For example, the sample label data may include top K transmit beam identifiers and/or top K beam pair identifiers in set A. The top K beam pairs may include top K transmit beams and top K preferred receive beams.

It can be understood that, in the embodiment, set B may be a wide beam, and set A may be a narrow beam. The top K transmit beam identifiers may be top K transmit beam IDs, and the top K beam pair identifiers may be top K beam pair IDs.

For example, the preferred transmit beam included in the third beam pair may be the same as the preferred transmit beam in the second reference signal set.

For another example, preferred transmit beams included in the third beam pair may not be completely the same as or different from preferred transmit beams in the second reference signal set. It can be understood that the second reference signal set is set A, and the preferred transmit beam in the second reference signal set is the preferred transmit beam in set A output by the beam prediction model; and the third beam pair is the preferred beam pair in set A output by the beam prediction model. Since the beam pair is composed of the receive beam and the transmit beam, it can be contemplated that some transmit beams may not meet a condition corresponding to the preferred transmit beam, but if they form beam pairs with some receive beams, they may meet a condition corresponding to the preferred beam pair. Some transmit beams meet the condition corresponding to the preferred transmit beam, but if they form beam pairs with some receive beams, they may not meet the condition corresponding to the preferred beam pair. Therefore, the preferred transmit beams included in the preferred beam pairs in set A may be partially the same as or completely different from the preferred transmit beams in set A.

In the present disclosure, the sample data collected by the terminal may include a variety of labels for the beam prediction model operation, so that when the beam prediction model is operated, the network device can use the sample data reported by the terminal for operation, thereby improving the accuracy of the output result of the beam prediction model.

In the method for collecting the data provided by embodiments of the present disclosure, the second condition includes at least one of: the first reference signal set and the second reference signal set being different, and the output of the beam prediction model being the preferred beam information; or the first reference signal set being a subset of the second reference signal set, or the first reference signal set being the same as the second reference signal set, and the output of the beam prediction model being the preferred beam information.

In some embodiments, the second condition may be that the first reference signal set and the second reference signal set are different, and the output of the beam prediction model is the preferred beam information.

For example, the second condition is that set B and set A are different, and the output of the beam prediction model is the preferred beam information, for example, the beam prediction model outputs top K pieces of transmit beam information, top K pieces of receive beam information and/or top K pieces of beam pair information.

It can be understood that in the embodiment, set B can be a wide beam and set A can be a narrow beam. The preferred beam information can be a preferred transmit beam identifier, a preferred receive beam identifier and/or a preferred beam pair identifier, such as top K transmit beam IDs, top K receive beam IDs and/or top K beam pair IDs.

The preferred beam information output by the beam prediction model may be one or more of the preferred transmit beam in the second reference signal set, the preferred receive beam in the second reference signal set, and the preferred beam pair in the second reference signal set output by the beam prediction model. The preferred beam pair in the second reference signal set includes the preferred transmit beam and the preferred receive beam. It can be understood that the preferred transmit beams included in the preferred beam pairs may be the same as, partially the same as, or completely different from the preferred transmit beams in the second reference signal set. The preferred receive beams included in the preferred beam pairs may be the same as, partially the same as, or completely different from the preferred receive beams in the second reference signal set.

A beam pair is composed of a receive beam and a transmit beam. For example, some transmit beams may not meet a condition corresponding to the preferred transmit beam, but if they form beam pairs with some receive beams, they may meet a condition corresponding to the preferred beam pair. Some transmit beams meet the condition corresponding to the preferred transmit beam, but if they form beam pairs with some receive beams, they may not meet the condition corresponding to the preferred beam pair. For another example, some receive beams may not meet a condition corresponding to the preferred receive beam, but when they form beam pairs with some transmit beams, they may meet the condition corresponding to the preferred beam pair. Some receive beams meet the condition corresponding to the preferred receive beam, but when they form beam pairs with some transmit beams, they may not meet the condition corresponding to the preferred beam pair.

Therefore, the preferred receive beams included in the preferred beam pairs may be the same as, partially the same as, or completely different from the preferred receive beams in the second reference signal set.

In some embodiments, the second condition may be that the first reference signal set is a subset of the second reference signal set, or the first reference signal set is the same as the second reference signal set, and the output of the beam prediction model is the preferred beam information.

For example, the second condition is that set B is a subset of set A, or set B is equal to set A, and the output of the beam prediction model is the preferred beam information, for example, the beam prediction model outputs top K pieces of transmit beam information, top K pieces of receive beam information and/or top K pieces of beam pair information.

It can be understood that the preferred beam information can be a preferred transmit beam identifier, a preferred receive beam identifier and/or a preferred beam pair identifier, such as top K transmit beam IDs, top K receive beam IDs and/or top K beam pair IDs.

It should be understood that the third condition in the present disclosure may further include: the first reference signal set and the second reference signal set being different, and the output of the beam prediction model being the preferred beam information; and the first reference signal set being a subset of the second reference signal set, or the first reference signal set being the same as the second reference signal set, and the output of the beam prediction model being the preferred beam information.

The present disclosure is adapted to a plurality of different reference signal sets and beam prediction models. Accordingly, in such cases, the terminal collects the sample data including various labels for the beam prediction model operation, so that when the beam prediction model is operated, the network device can use the sample data reported by the terminal for operation, thereby improving the accuracy of the output result of the beam prediction model.

In the method for collecting the data provided by embodiments of the present disclosure, the sample data includes at least one of the following parameters: the amount of sample data; a scene and/or a sample parameter corresponding to the sample data; a beam prediction model identifier and/or a beam prediction model function; or a timestamp corresponding to the sample data.

In some embodiments, the sample data may include the amount of sample data.

It can be understood that the amount of sample data is used to identify how much sample data the terminal reports to the network device.

In some embodiments, the sample data may include the scene and/or the sample parameter corresponding to the sample data.

For example, the scene corresponding to the sample data may refer to a scene in which the terminal that measures the sample data is located, such as an Uma scene, an Umi scene, an indoor scene, and the like.

For another example, the sample parameter corresponding to the sample data may be the number of Rx beams of the terminal, a beam width, a beam angle, a moving speed of the terminal, an antenna configuration of the terminal, the number of antenna panels, and other parameters

Alternatively, the scene may include more possible scenes according to actual conditions, and the sample parameter may include more possible parameters according to actual conditions, which are not limited in the present disclosure.

In some embodiments, the sample data may include the beam prediction model identifier and/or the beam prediction model function.

The beam prediction model identifier can be used to uniquely indicate which AI model is operated. The beam prediction model function can indicate what the AI model is used for. For example, it indicates that the AI model is used for beam prediction, for location prediction, for CSI compression, for terminal mobility management, and so on.

In some embodiments, the sample data may include the timestamp corresponding to the sample data.

For example, the timestamp corresponding to the sample data may be indicated explicitly or implicitly. Explicit indication means indicating the timestamp corresponding to each piece of sample data. Implicit indication means that time period lengths corresponding to individual pieces of sample data are the same, and each piece of sample data is recorded, stored, transmitted, etc. in chronological order. For example, each piece of sample data is sequentially arranged in chronological order.

It should be understood that the sample data in the present disclosure may further include any two, three or four of the above items. For example, the sample data may further include: the amount of sample data, and the timestamp corresponding to the sample data; the scene and/or the sample parameter corresponding to the sample data, and the timestamp corresponding to the sample data; the amount of sample data, the scene and/or the sample parameter corresponding to the sample data, and the timestamp corresponding to the sample data; the amount of sample data, the scene and/or the sample parameter corresponding to the sample data, and the timestamp corresponding to the sample data; the amount of sample data, the scene and/or the sample parameter corresponding to the sample data, the beam prediction model identifier and/or the beam prediction model function, and the timestamp corresponding to the sample data. For the convenience of description, the present disclosure does not list them one by one here.

In some embodiments, the sample data may include the input sample data and/or the sample label data, and may further include one or more of the amount of sample data, the scene and/or the sample parameter corresponding to the sample data, the beam prediction model identifier and/or the beam prediction model function, and the timestamp corresponding to the sample data, which is not limited by the present disclosure.

The present disclosure provides a variety of information included in the sample data, so that when the beam prediction model is operated, the network device can use the sample data reported by the terminal for operation, thereby improving the accuracy of the output result of the beam prediction model.

In the method for collecting the data provided by embodiments of the present disclosure, the sample data is used to operate the beam prediction model. The data collection indication information at least includes measurement configuration information. The measurement configuration information includes at least one of: at least one reference signal set; a data collection start time; or a data collection end time.

In some embodiments, the sample data obtained by the terminal measuring the reference signal can be used to perform the corresponding operation on the beam prediction model. The beam prediction model can be an AI model for beam prediction. The data collection indication information sent by the network device shall include at least the measurement configuration information, and the measurement configuration information may include a parameter indicating the terminal to perform measurement. The terminal can measure the reference signal based on the measurement configuration information to obtain the sample data.

For example, the measurement configuration information includes some parameters indicating the terminal to perform measurement, such as indicating when to perform measurement by the terminal, which reference signals the terminal measures, etc. Accordingly, the terminal can perform corresponding measurements on the reference signals based on these parameters and obtain corresponding sample data.

In some embodiments, the measurement configuration information may include the at least one reference signal set.

For example, the network device informs, through the measurement configuration information, the terminal which reference signal sets are configured. When a plurality of reference signal sets are configured, a relationship between respective reference signal sets also needs to be indicated. For example, two reference signal sets, that is, set B and set A, are configured, and the measurement configuration information also needs to indicate a beam relationship between set B and set A. That is, it indicates that set B is a subset of set A, or set B and set A are the same, or set B and set A are different. If set B is the subset of set A, it can indicate which reference signals in set A are included in set B. If set B and set A are different, it can also indicate beams corresponding to which reference signals in set A may be covered by a beam corresponding to one reference signal in set B.

In some embodiments, the measurement configuration information may include the data collection start time, and the data collection start time indicates a time when the network device sends the reference signal set.

For example, the data collection start time may be implicitly indicated, for example, the data collection start time is indicated by a time when the network device sends the reference signal. In another example, the data collection start time may be explicitly indicated, that is, the start time of data collection by the terminal is directly indicated.

In some embodiments, the measurement configuration information may include the data collection end time, and the data collection end time indicates a time when the terminal ends the measurement.

For example, the data collection end time may be implicitly indicated, for example, the data collection end time is indicated by a time when the network device stops sending the reference signal. In another example, the data collection end time may be explicitly indicated, that is, the end time of data collection by the terminal is directly indicated.

It should be understood that the measurement configuration information in the present disclosure may further include any two or three of the above items, and the measurement configuration information may further include: the at least one reference signal set, and the data collection start time; the at least one reference signal set, and the data collection end time; the data collection start time, and the data collection end time; the at least one reference signal set, the data collection start time, and the data collection end time.

The present disclosure provides a variety of information included in the measurement configuration information, which facilitates the terminal to collect the corresponding sample data, so that when the beam prediction model is operated, the sample data of the terminal can be used for operation, thereby improving the accuracy of the output result of the beam prediction model.

In the method for collecting the data provided by embodiments of the present disclosure, FIG. 6 shows a flowchart of another method for collecting data according to an embodiment of the present disclosure. As shown in FIG. 6, the sample data is used to operate the beam prediction model. In response to the beam prediction model being operated on the terminal, the data collection indication information includes measurement configuration information. The method may further include the following step:

in step S51, a data collection request is received.

In some embodiments, the beam prediction model can be operated on the terminal. In this scene, the network device can receive the data collection request sent by the terminal. The data collection request is configured to indicate to the network device to configure the data collection indication information. That is, the data collection request is configured to indicate to the network device to configure the measurement configuration information.

For example, the network device may receive the data collection request sent by the terminal, configure the measurement configuration information based on the data collection request, and send the measurement configuration information to the terminal.

The present disclosure can be applicable to a scene where the beam prediction model is operated on the terminal. The measurement configuration information is used to indicate to the terminal to collect the corresponding sample data, so that when the beam prediction model is operated, the terminal can use the sample data of the terminal for operation, thereby improving the accuracy of the output result of the beam prediction model.

In the method for collecting the data provided by embodiments of the present disclosure, the data collection request may include at least one of the following parameters: the amount of sample data; or reference signal set configuration information.

In some embodiments, the data collection request may include the amount of sample data.

It can be understood that the amount of sample data is used to inform the network device of the amount of sample data used for the beam prediction model operation.

In some embodiments, the data collection request may include the reference signal set configuration information.

It can be understood that the reference signal set configuration information informs the network device whether the terminal uses one reference signal set or two reference signal sets to collect the sample data.

For example, one reference signal set may correspond to a scene where set B is the same as set A, or set B is a subset of set A. Two reference signal sets may correspond to a scene where set B is a wide beam and set A is a narrow beam, or set B is a subset of set A. In other words, the reference signal set configuration information may indicate the relationship between set B and set A.

The present disclosure provides a variety of information included in the data collection request, which facilitates the network device to configure and send the corresponding reference signal in a scene where the beam prediction model is operated on the terminal. Accordingly, the terminal can collect the corresponding sample data, so that when the beam prediction model is operated, the terminal can use the sample data of the terminal for operation, thereby improving the accuracy of the output result of the beam prediction model.

In the method for collecting the data provided by embodiments of the present disclosure, the data collection indication information further includes report configuration information. The report configuration information is configured to indicate at least one of the following reporting manners: periodic reporting; aperiodic reporting; or RRC signaling or UCI-based reporting.

In some embodiments, the data collection indication information sent by the network device may further include report configuration information. The report configuration information may include a parameter indicating the terminal to report the sample data to the network device, such as indicating a reporting manner in which the terminal reports the sample data. Therefore, the terminal may report the sample data based on the report configuration information.

In some embodiments, the report configuration information is configured to indicate that the measurement result is reported in the periodic reporting manner.

In some embodiments, the report configuration information is configured to indicate that the measurement result is reported in the aperiodic reporting manner.

In some embodiments, the report configuration information is configured to indicate that the measurement result is reported in the RRC signaling or UCI-based reporting manner.

It should be understood that the measurement configuration information in the present disclosure may further include any two or three of the above items. For example, the report configuration information is configured to indicate: the periodic reporting, and the aperiodic reporting; the periodic reporting, and the RRC signaling or UCI-based reporting; the aperiodic reporting, and the RRC signaling or UCI-based reporting; and the periodic reporting, the aperiodic reporting, and the RRC signaling or UCI-based reporting.

The present disclosure provides a variety of reporting manners, which can be applied to different reporting scenes, where when the beam prediction model is operated, the network device can use the sample data reported by the terminal for operation, thereby improving the accuracy of the output result of the beam prediction model.

In the method for collecting the data provided by embodiments of the present disclosure, FIG. 7 shows a flowchart of yet another method for collecting data according to an embodiment of the present disclosure. As shown in FIG. 7, the beam prediction model is operated on the network device. The data collection indication information is configured to indicate to the terminal to measure the reference signal to obtain the sample data, and the report configuration information is configured to indicate to the terminal to send the sample data. The method may further include the following step:

in step S61, the sample data is received.

In some embodiments, in a scene where the beam prediction model is operated on the network device, the data collection indication information sent by the network device may include the measurement configuration information and the report configuration information. The measurement configuration information may include a parameter indicating the terminal to perform the measurement, which is used to indicate to the terminal to measure the reference signal to obtain the sample data, so that the terminal can measure the reference signal based on the measurement configuration information to obtain the sample data. The report configuration information may include a parameter indicating the terminal to report the sample data to the network device, which is used to indicate to the terminal to send the sample data.

In some embodiments, the network device may receive the sample data sent, based on the report configuration information, by the terminal.

For example, the report configuration information may include a parameter indicating the terminal to report the sample data to the network device, such as indicating a manner in which the terminal reports the sample data, so that the terminal can send the sample data to the network device based on the reporting manner indicated by the report configuration information. The network device can operate the beam prediction model using the received sample data.

The present disclosure can be applicable to a scene where the beam prediction model is operated on the network device. The terminal is indicated, through the measurement configuration information and the report configuration information, to collect the corresponding sample data and report it to the network device, so that when the beam prediction model is operated, the network device can use the sample data reported by the terminal for operation, thereby improving the accuracy of the output result of the beam prediction model.

In the method for collecting the data provided by embodiments of the present disclosure, in response to the report configuration information being configured to indicate the periodic reporting, receiving the sample data in the S61 may include: receiving one or more pieces of sample data.

In some embodiments, in response to the report configuration information being configured to indicate the periodic reporting, the network device may receive the one or more pieces of sample data. That is, the network device receives the sample data sent by the terminal, which may be the one or more pieces of sample data. In other words, the terminal periodically reports the one or more pieces of sample data.

It can be understood that the amount of sample data in the sample data reported by the terminal each time mainly depends on the amount of sample data available to the terminal in the corresponding reporting period.

The present disclosure is applicable to a case where the measurement result is reported periodically, so that when the beam prediction model is operated, the network device can use the sample data reported by the terminal for operation, thereby improving the accuracy of the output result of the beam prediction model.

In the method for collecting the data provided by embodiments of the present disclosure, in response to the report configuration information being configured to indicate the aperiodic reporting, the sample data at least includes the amount of sample data.

In some embodiments, in response to the report configuration information being configured to indicate the aperiodic reporting, the sample data should include at least the amount of sample data.

It can be understood that since the terminal reports the sample data aperiodically, the amount of sample data in each reported sample data may be different. Therefore, each time the terminal reports the sample data, information indicating the amount of sample data should be included, that is, it is necessary to inform how much sample data is reported.

The present disclosure is applicable to a case where the measurement result is reported aperiodically, so that when the beam prediction model is operated, the network device can use the sample data reported by the terminal for operation, thereby improving the accuracy of the output result of the beam prediction model.

In the method for collecting the data provided by embodiments of the present disclosure, in response to the report configuration information being configured to indicate the RRC signaling or UCI-based reporting, receiving the sample data in the S61 includes: receiving the sample data through a PUSCH or a PUCCH.

In some embodiments, in response to the report configuration information being configured to indicate the RRC signaling or UCI-based reporting, the network device may receive, through the PUSCH or the PUCCH, the sample data sent by the terminal, and the sample data is carried on the RRC signaling or the UCI.

The present disclosure is applicable to a case where the measurement result is reported based on the RRC signaling or the UCI, so that when the beam prediction model is operated, the network device can use the sample data reported by the terminal for operation, thereby improving the accuracy of the output result of the beam prediction model.

In the method for collecting the data provided by embodiments of the present disclosure, operating the beam prediction model includes at least one of: training the beam prediction model; monitoring the beam prediction model; or performing deduction based on the beam prediction model.

In some embodiments, operating the beam prediction model may be training the beam prediction model.

In some embodiments, operating the beam prediction model may be monitoring the beam prediction model.

In some embodiments, operating the beam prediction model may be performing the deduction based on the beam prediction model.

It should be understood that operating the beam prediction model in the present disclosure may further include: training the beam prediction model and monitoring the beam prediction model; training the beam prediction model and performing the deduction based on the beam prediction model; monitoring the beam prediction model and performing the deduction based on the beam prediction model; training the beam prediction model, monitoring the beam prediction model and performing the deduction based on the beam prediction model.

The present disclosure provides a variety of scenes for operating the beam prediction model, so that in different scenes, when the beam prediction model is operated, the sample data of the terminal can be used for operation, thereby improving the accuracy of the output result of the beam prediction model.

It should be noted that those skilled in the art can understand that the various implementation methods/embodiments involved in the embodiments of the present disclosure can be used in conjunction with the aforementioned embodiments or can be used independently. Whether used alone or in conjunction with the aforementioned embodiments, the implementation principle is similar. In the implementation of the present disclosure, some embodiments are described in terms of implementation methods used together. Alternatively, those skilled in the art can understand that such examples are not limitations of the embodiments of the present disclosure.

Based on the same concept, embodiments of the present disclosure further provide an apparatus and a device for collecting data.

It can be understood that in order to implement the above-mentioned functions, the apparatus and the device for collecting the data provided in embodiments of the present disclosure include corresponding hardware structures and/or software modules for executing respective functions. In combination with units and algorithm steps of various examples disclosed in embodiments of the present disclosure, embodiments of the present disclosure may be implemented by in a form of hardware or a combination of the hardware and computer software. Whether a certain function is implemented in the fashion of hardware or in the fashion that the computer software drives the hardware depends on a particular application and design constraints of the technical solution. A person skilled in the art may implement the described functions with different methods for each particular application, but such an implementation shall not be regarded as going beyond the scope of the technical solution according to embodiments of the present disclosure.

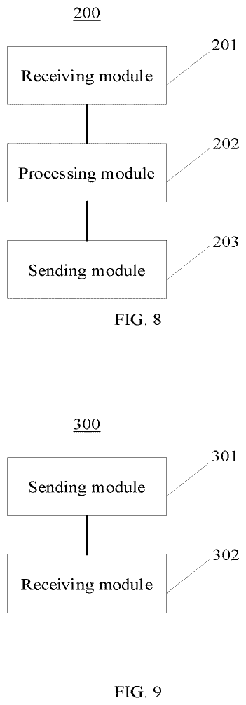

FIG. 8 shows a schematic diagram of an apparatus for collecting data according to an embodiment of the present disclosure. Referring to FIG. 8, the apparatus 200 is configured in a terminal, and the apparatus 200 includes: a receiving module 201, configured to receive data collection indication information; and a processing module 202, configured to measure a reference signal based on the data collection indication information to obtain sample data.

In the present disclosure, the data collection indication information indicates that the terminal should collect the corresponding sample data, so that when a beam prediction model is operated, the sample data collected by the terminal can be used for operation, thereby improving accuracy of an output result of the beam prediction model.

In some embodiments, the sample data includes input sample data, and the input sample data is used as an input when a beam prediction model is operated; the reference signal includes a reference signal in a first reference signal set and/or a second reference signal set, an input of the beam prediction model is beam information corresponding to the reference signal in the first reference signal set, an output of the beam prediction model is beam information or preferred beam information corresponding to the reference signal in the second reference signal set, and the input sample data includes at least one of the following parameters: beam information of a first transmit beam corresponding to the reference signal in the first reference signal set, or beam information of a first beam pair corresponding to the reference signal in the first reference signal set, wherein the first beam pair includes the first transmit beam and a first receive beam; a reference signal identifier of the reference signal in the first reference signal set; a first receive beam identifier; or a first beam pair identifier.

In the present disclosure, the sample data collected by the terminal may include a variety of input sample data for the beam prediction model operation, so that when the beam prediction model is operated, the network device can use the sample data reported by the terminal for operation, thereby improving the accuracy of the output result of the beam prediction model.

In some embodiments, the sample data includes sample label data, and the sample label data is used as a label when a beam prediction model is operated; in response to a first reference signal set, a second reference signal set and an output of the beam prediction model satisfying a first condition, the sample label data includes at least one of the following parameters: beam information of a second transmit beam corresponding to a reference signal in the second reference signal set, or beam information of a second beam pair corresponding to the reference signal in the second reference signal set, wherein the second beam pair includes the second transmit beam and a second receive beam; a reference signal identifier of the reference signal in the second reference signal set; a second receive beam identifier; or a second beam pair identifier.

In the present disclosure, the sample data collected by the terminal may include a variety of labels for the beam prediction model operation, so that when the beam prediction model is operated, the network device can use the sample data reported by the terminal for operation, thereby improving the accuracy of the output result of the beam prediction model.

In some embodiments, the first condition includes at least one of: the first reference signal set and the second reference signal set being different, and the output of the beam prediction model being beam information corresponding to the second reference signal set; or the first reference signal set being a subset of the second reference signal set, or the first reference signal set being the same as the second reference signal set, and the output of the beam prediction model being the beam information corresponding to the second reference signal set.

The present disclosure is adapted to a plurality of different reference signal sets and beam prediction models. Accordingly, in such cases, the terminal collects the sample data including various labels for the beam prediction model operation, so that when the beam prediction model is operated, the network device can use the sample data reported by the terminal for operation, thereby improving the accuracy of the output result of the beam prediction model.

In some embodiments, the sample data includes sample label data, and the sample label data is used as a label when a beam prediction model is operated; and in response to a first reference signal set, a second reference signal set and an output of the beam prediction model satisfying a second condition, the sample label data includes an identifier of a preferred transmit beam or an identifier of a third beam pair in the second reference signal set, and the third beam pair includes the preferred transmit beam and a preferred receive beam.

In the present disclosure, the sample data collected by the terminal may include a variety of labels for the beam prediction model operation, so that when the beam prediction model is operated, the network device can use the sample data reported by the terminal for operation, thereby improving the accuracy of the output result of the beam prediction model.

In some embodiments, the second condition includes at least one of: the first reference signal set and the second reference signal set being different, and the output of the beam prediction model being preferred beam information; or the first reference signal set being a subset of the second reference signal set, or the first reference signal set being the same as the second reference signal set, and the output of the beam prediction model being the preferred beam information.

The present disclosure is adapted to a plurality of different reference signal sets and beam prediction models. Accordingly, in such cases, the terminal collects the sample data including various labels for the beam prediction model operation, so that when the beam prediction model is operated, the network device can use the sample data reported by the terminal for operation, thereby improving the accuracy of the output result of the beam prediction model.

In some embodiments, the sample data includes at least one of the following parameters: the amount of sample data; a scene and/or a sample parameter corresponding to the sample data; a beam prediction model identifier and/or a beam prediction model function; or a timestamp corresponding to the sample data.

The present disclosure provides a variety of information included in the sample data, so that when the beam prediction model is operated, the network device can use the sample data reported by the terminal for operation, thereby improving the accuracy of the output result of the beam prediction model.

In some embodiments, the sample data is configured to operate a beam prediction model, and the data collection indication information at least includes measurement configuration information; and the measurement configuration information includes at least one of the following information: at least one reference signal set; a data collection start time; or a data collection end time.

The present disclosure provides a variety of information included in the measurement configuration information, which facilitates the terminal to collect the corresponding sample data, so that when the beam prediction model is operated, the sample data of the terminal can be used for operation, thereby improving the accuracy of the output result of the beam prediction model.

In some embodiments, the beam prediction model is operated on the terminal; the apparatus 200 further includes: a sending module 203, configured to send a data collection request, and the data collection request is configured to indicate to a network device to configure the data collection indication information.

The present disclosure can be applicable to a scene where the beam prediction model is operated on the terminal. The measurement configuration information is used to indicate to the terminal to collect the corresponding sample data, so that when the beam prediction model is operated, the terminal can use the sample data of the terminal for operation, thereby improving the accuracy of the output result of the beam prediction model.

In some embodiments, the data collection request includes at least one of the following parameters: the amount of sample data; or reference signal set configuration information.

The present disclosure provides a variety of information included in the data collection request, which facilitates the network device to configure and send the corresponding reference signal in a scene where the beam prediction model is operated on the terminal. Accordingly, the terminal can collect the corresponding sample data, so that when the beam prediction model is operated, the terminal can use the sample data of the terminal for operation, thereby improving the accuracy of the output result of the beam prediction model.

In some embodiments, the data collection indication information further includes report configuration information, and the report configuration information is configured to indicate at least one of the following reporting manners: periodic reporting; aperiodic reporting; or radio resource control (RRC) signaling or uplink control information (UCI)-based reporting.

The present disclosure provides a variety of reporting manners, which can be applied to different reporting scenes, where when the beam prediction model is operated, the network device can use the sample data reported by the terminal for operation, thereby improving the accuracy of the output result of the beam prediction model.

In some embodiments, the beam prediction model is operated on the network device; the processing module 202 is further configured to measure the reference signal based on the measurement configuration information to obtain the sample data; and the processing module 202 is further configured to send the sample data based on the report configuration information.

The present disclosure can be applicable to a scene where the beam prediction model is operated on the network device. The terminal is indicated, through the measurement configuration information and the report configuration information, to collect the corresponding sample data and report it to the network device, so that when the beam prediction model is operated, the network device can use the sample data reported by the terminal for operation, thereby improving the accuracy of the output result of the beam prediction model.

In some embodiments, in response to the report configuration information being configured to indicate the periodic reporting, the sending module 203 is further configured to send one or more pieces of sample data.

The present disclosure is applicable to a case where the measurement result is reported periodically, so that when the beam prediction model is operated, the network device can use the sample data reported by the terminal for operation, thereby improving the accuracy of the output result of the beam prediction model.

In some embodiments, in response to the report configuration information being configured to indicate the aperiodic reporting, the sample data at least includes the amount of sample data.

The present disclosure is applicable to a case where the measurement result is reported aperiodically, so that when the beam prediction model is operated, the network device can use the sample data reported by the terminal for operation, thereby improving the accuracy of the output result of the beam prediction model.

In some embodiments, in response to the report configuration information being configured to indicate the RRC signaling or UCI-based reporting, the sending module 203 is further configured to send the sample data through a physical uplink shared channel (PUSCH) or a physical uplink control channel (PUCCH).

The present disclosure is applicable to a case where the measurement result is reported based on the RRC signaling or the UCI, so that when the beam prediction model is operated, the network device can use the sample data reported by the terminal for operation, thereby improving the accuracy of the output result of the beam prediction model.

In some embodiments, operating the beam prediction model includes at least one of: training the beam prediction model; monitoring the beam prediction model; or performing deduction based on the beam prediction model.

The present disclosure provides a variety of scenes for operating the beam prediction model, so that in different scenes, when the beam prediction model is operated, the sample data of the terminal can be used for operation, thereby improving the accuracy of the output result of the beam prediction model.

FIG. 9 shows a schematic diagram of another apparatus for collecting data according to an embodiment of the present disclosure. Referring to FIG. 9, the apparatus 300 is configured in a network device, and the apparatus 300 includes: a sending module 301, configured to send data collection indication information, and the data collection indication information is configured to indicate to a terminal to measure a reference signal to obtain sample data.

In the present disclosure, the data collection indication information indicates that the terminal should collect the corresponding sample data, so that when a beam prediction model is operated, the sample data collected by the terminal can be used for operation, thereby improving accuracy of an output result of the beam prediction model.

In some embodiments, the sample data includes input sample data, and the input sample data is used as an input when a beam prediction model is operated; the reference signal includes a reference signal in a first reference signal set and/or a second reference signal set, an input of the beam prediction model is beam information corresponding to the reference signal in the first reference signal set, an output of the beam prediction model is beam information or preferred beam information corresponding to the reference signal in the second reference signal set, and the input sample data includes at least one of the following parameters: beam information of a first transmit beam corresponding to the reference signal in the first reference signal set, or beam information of a first beam pair corresponding to the reference signal in the first reference signal set, wherein the first beam pair includes the first transmit beam and a first receive beam; a reference signal identifier of the reference signal in the first reference signal set; a first receive beam identifier; or a first beam pair identifier.

In the present disclosure, the sample data collected by the terminal may include a variety of input sample data for the beam prediction model operation, so that when the beam prediction model is operated, the network device can use the sample data reported by the terminal for operation, thereby improving the accuracy of the output result of the beam prediction model.

In some embodiments, the sample data includes sample label data, and the sample label data is used as a label when a beam prediction model is operated; in response to a first reference signal set, a second reference signal set and an output of the beam prediction model satisfying a first condition, the sample label data includes at least one of the following parameters: beam information of a second transmit beam corresponding to a reference signal in the second reference signal set, or beam information of a second beam pair corresponding to the reference signal in the second reference signal set, wherein the second beam pair includes the second transmit beam and a second receive beam; a reference signal identifier of the reference signal in the second reference signal set; a second receive beam identifier; or a second beam pair identifier.

In the present disclosure, the sample data collected by the terminal may include a variety of labels for the beam prediction model operation, so that when the beam prediction model is operated, the network device can use the sample data reported by the terminal for operation, thereby improving the accuracy of the output result of the beam prediction model.

In some embodiments, the first condition includes at least one of: the first reference signal set and the second reference signal set being different, and the output of the beam prediction model being beam information corresponding to the second reference signal set; or the first reference signal set being a subset of the second reference signal set, or the first reference signal set being the same as the second reference signal set, and the output of the beam prediction model being the beam information corresponding to the second reference signal set.

The present disclosure is adapted to a plurality of different reference signal sets and beam prediction models. Accordingly, in such cases, the terminal collects the sample data including various labels for the beam prediction model operation, so that when the beam prediction model is operated, the network device can use the sample data reported by the terminal for operation, thereby improving the accuracy of the output result of the beam prediction model.

In some embodiments, the sample data includes sample label data, and the sample label data is used as a label when a beam prediction model is operated; and in response to a first reference signal set, a second reference signal set and an output of the beam prediction model satisfying a second condition, the sample label data includes an identifier of a preferred transmit beam or an identifier of a third beam pair in the second reference signal set, and the third beam pair includes the preferred transmit beam and a preferred receive beam.

In the present disclosure, the sample data collected by the terminal may include a variety of labels for the beam prediction model operation, so that when the beam prediction model is operated, the network device can use the sample data reported by the terminal for operation, thereby improving the accuracy of the output result of the beam prediction model.

In some embodiments, the second condition includes at least one of: the first reference signal set and the second reference signal set being different, and the output of the beam prediction model being preferred beam information; or the first reference signal set being a subset of the second reference signal set, or the first reference signal set being the same as the second reference signal set, and the output of the beam prediction model being the preferred beam information.

The present disclosure is adapted to a plurality of different reference signal sets and beam prediction models. Accordingly, in such cases, the terminal collects the sample data including various labels for the beam prediction model operation, so that when the beam prediction model is operated, the network device can use the sample data reported by the terminal for operation, thereby improving the accuracy of the output result of the beam prediction model.

In some embodiments, the sample data includes at least one of the following parameters: the amount of sample data; a scene and/or a sample parameter corresponding to the sample data; a beam prediction model identifier and/or a beam prediction model function; or a timestamp corresponding to the sample data.

The present disclosure provides a variety of information included in the sample data, so that when the beam prediction model is operated, the network device can use the sample data reported by the terminal for operation, thereby improving the accuracy of the output result of the beam prediction model.

In some embodiments, the sample data is configured to operate a beam prediction model, and the data collection indication information at least includes measurement configuration information; and the measurement configuration information includes at least one of the following information: at least one reference signal set; a data collection start time; or a data collection end time.

The present disclosure provides a variety of information included in the measurement configuration information, which facilitates the terminal to collect the corresponding sample data, so that when the beam prediction model is operated, the sample data of the terminal can be used for operation, thereby improving the accuracy of the output result of the beam prediction model.

In some embodiments, the beam prediction model is operated on the terminal; the apparatus 300 further includes: a receiving module 302, configured to receive a data collection request, and the data collection request is configured to indicate to the network device to configure the data collection indication information.

The present disclosure can be applicable to a scene where the beam prediction model is operated on the terminal. The measurement configuration information is used to indicate to the terminal to collect the corresponding sample data, so that when the beam prediction model is operated, the terminal can use the sample data of the terminal for operation, thereby improving the accuracy of the output result of the beam prediction model.

In some embodiments, the data collection request includes at least one of the following parameters: the amount of sample data; or reference signal set configuration information.

The present disclosure provides a variety of information included in the data collection request, which facilitates the network device to configure and send the corresponding reference signal in a scene where the beam prediction model is operated on the terminal. Accordingly, the terminal can collect the corresponding sample data, so that when the beam prediction model is operated, the terminal can use the sample data of the terminal for operation, thereby improving the accuracy of the output result of the beam prediction model.

In some embodiments, the data collection indication information further includes report configuration information; and the report configuration information is configured to indicate at least one of the following reporting manners: periodic reporting; aperiodic reporting; or radio resource control (RRC) signaling or uplink control information (UCI)-based reporting.

The present disclosure provides a variety of reporting manners, which can be applied to different reporting scenes, where when the beam prediction model is operated, the network device can use the sample data reported by the terminal for operation, thereby improving the accuracy of the output result of the beam prediction model.

In some embodiments, the beam prediction model is operated on the network device, the data collection indication information is configured to indicate to the terminal to measure the reference signal to obtain the sample data, and the report configuration information is configured to indicate to the terminal to send the sample data; the receiving module 302 is further configured to receive the sample data.

The present disclosure can be applicable to a scene where the beam prediction model is operated on the network device. The terminal is indicated, through the measurement configuration information and the report configuration information, to collect the corresponding sample data and report it to the network device, so that when the beam prediction model is operated, the network device can use the sample data reported by the terminal for operation, thereby improving the accuracy of the output result of the beam prediction model.

In some embodiments, in response to the report configuration information being configured to indicate the periodic reporting, the receiving module 302 is further configured to receive one or more pieces of sample data.

The present disclosure is applicable to a case where the measurement result is reported periodically, so that when the beam prediction model is operated, the network device can use the sample data reported by the terminal for operation, thereby improving the accuracy of the output result of the beam prediction model.

In some embodiments, in response to the report configuration information being configured to indicate the aperiodic reporting, the sample data at least includes the amount of sample data.

The present disclosure is applicable to a case where the measurement result is reported aperiodically, so that when the beam prediction model is operated, the network device can use the sample data reported by the terminal for operation, thereby improving the accuracy of the output result of the beam prediction model.

In some embodiments, in response to the report configuration information being configured to indicate the RRC signaling or UCI-based reporting, the receiving module 302 is further configured to receive the sample data through a physical uplink shared channel (PUSCH) or a physical uplink control channel (PUCCH).

The present disclosure is applicable to a case where the measurement result is reported based on the RRC signaling or the UCI, so that when the beam prediction model is operated, the network device can use the sample data reported by the terminal for operation, thereby improving the accuracy of the output result of the beam prediction model.

In some embodiments, operating the beam prediction model includes at least one of: training the beam prediction model; monitoring the beam prediction model; or performing deduction based on the beam prediction model.

The present disclosure provides a variety of scenes for operating the beam prediction model, so that in different scenes, when the beam prediction model is operated, the sample data of the terminal can be used for operation, thereby improving the accuracy of the output result of the beam prediction model.

Regarding the apparatus in the above embodiments, a specific manner in which each module performs operations has been described in detail in the method embodiments, which will not be elaborated here.

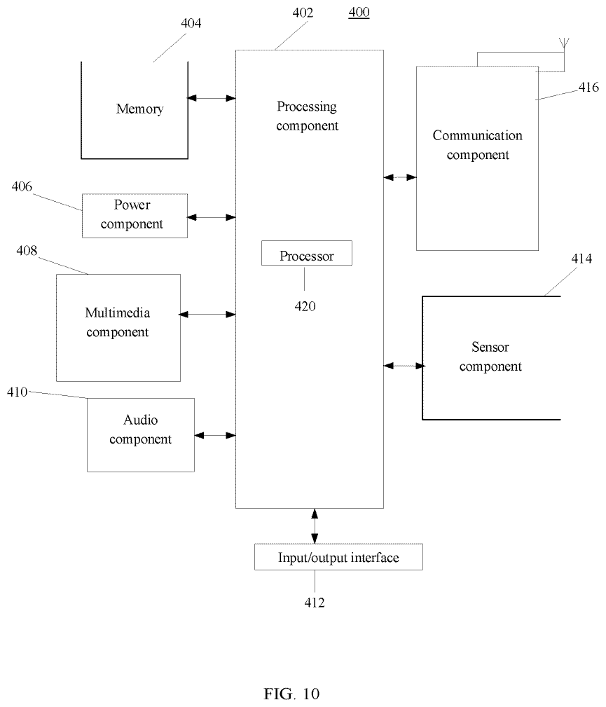

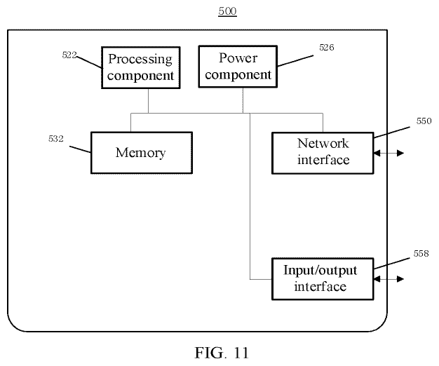

FIG. 10 shows a schematic diagram of a device for collecting data according to an embodiment of the present disclosure. For example, the device 400 may be any terminal such as a mobile phone, a computer, a digital broadcast terminal, a messaging device, a gaming console, a tablet device, a medical device, an exercise device, a personal digital assistant, etc.

Referring to FIG. 10, the device 400 may include one or more of the following components: a processing component 402, a memory 404, a power component 406, a multimedia component 408, an audio component 410, an input/output (I/O) interface 412, a sensor component 414, and a communication component 416.

The processing component 402 typically controls overall operations of the device 400, such as the operations associated with display, telephone calls, data communications, camera operations, and recording operations. The processing component 402 may include one or more processors 420 to execute instructions to complete all or part of the steps in the above described methods. Moreover, the processing component 402 may include one or more modules which facilitate the interaction between the processing component 402 and other components. For example, the processing component 402 may include a multimedia module to facilitate the interaction between the multimedia component 408 and the processing component 402.

The memory 404 is configured to store various types of data to support the operation of the device 400. Examples of such data include instructions for any applications or methods operated on the device 400, contact data, phonebook data, messages, pictures, video, etc. The memory 404 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 406 provides power to various components of the device 400. The power component 406 may include a power management system, one or more power sources, and any other components associated with the generation, management, and distribution of power in the device 400.

The multimedia component 408 includes a screen providing an output interface between the device 400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 408 includes a front camera and/or a rear camera. The front camera and the rear camera may receive an external multimedia datum while the device 400 is in an operation mode, such as a photographing mode or a video mode. Each of the front camera and the rear camera may be a fixed optical lens system or have focus and optical zoom capability.

The audio component 410 is configured to output and/or input audio signals. For example, the audio component 410 includes a microphone (MIC) configured to receive an external audio signal when the device 400 is in an operation mode, such as a call mode, a recording mode, and a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and peripheral interface modules, such as a keyboard, a click wheel, buttons, and the like. The buttons may include, but are not limited to, a home button, a volume button, a starting button, and a locking button.

The sensor component 414 includes one or more sensors to provide state assessments of various aspects of the device 400. For example, the sensor component 414 may detect an open/closed state of the device 400, relative positioning of components, e.g., the display and the keypad, of the device 400, a change in position of the device 400 or a component of the device 400, a presence or absence of user contact with the device 400, an orientation or an acceleration/deceleration of the device 400, and a change in temperature of the device 400. The sensor component 414 may include a proximity sensor configured to detect the presence of nearby objects without any physical contact. The sensor component 414 may further include a light sensor, such as a CMOS or CCD image sensor, for use in imaging applications. In some embodiments, the sensor component 414 may further include an accelerometer sensor, a gyroscope sensor, a magnetic sensor, a pressure sensor, or a temperature sensor.

The communication component 416 is configured to facilitate communication, wired or wirelessly, between the device 400 and other devices. The device 400 may access a wireless network based on a communication standard, such as Wi-Fi, 2G or 3G, or a combination thereof. In an embodiment, the communication component 416 receives a broadcast signal or broadcast associated information from an external broadcast management system via a broadcast channel. In an embodiment, the communication component 416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the device 400 may be implemented with one or more application specific integrated circuits (ASICs), digital signal processors (DSPs), digital signal processing devices (DSPDs), programmable logic devices (PLDs), field programmable gate arrays (FPGAs), controller, micro-controller, microprocessors, or other electronic components, for performing the above described methods.

In an embodiment of the present disclosure, there is further provided a non-transitory computer readable storage medium including instructions, such as the memory 404 including instructions, the above instructions may be executed by the processor 420 in the device 400 for completing the above-described methods. For example, the non-transitory computer-readable storage medium may be a ROM, a Random Access Memory (RAM), a CD-ROM, a magnetic tape, a floppy disc, an optical data storage device, and the like.

FIG. 11 shows a schematic diagram of another device for collecting data according to an embodiment of the present disclosure. For example, the device 500 may be provided as a base station or a server. Referring to FIG. 11, the device 500 includes a processing component 522, which further includes one or more processors and a memory resource represented by a memory 532 for storing instructions executable by the processing component 522, such as an application program. The application program stored in the memory 532 may include one or more modules, each corresponding to a set of instructions. In addition, the processing component 522 is configured to execute the instructions to execute the aforementioned method.

The device 500 may further include: a power component 526 configured to perform power management of the device 500, a wired or wireless network interface 550 configured to connect the device 500 to the network, and an input/output (I/O) interface 558. The device 500 may operate an operating system stored in the memory 532, such as Windows Server™, Mac OS X™, Unix™, Linux™, FreeBSD™, or the like.

In the present disclosure, the data collection indication information indicates that the terminal should collect the corresponding sample data, so that when a beam prediction model is operated, the sample data collected by the terminal can be used for operation, thereby improving accuracy of an output result of the beam prediction model.

It can be further understood that in the present disclosure, “a plurality” refers to two or more, and other quantifiers are analogous to it. “and/or” is used to describe an associated relationship between associated objects and means three relationships, for instance, A and/or B may mean A alone, A and B together, and B alone. The character “/” generally indicates that the associated objects are in an “or” relationship. Singular forms “a”, “an” and “the” are intended to include plural forms as well, unless the context clearly indicates otherwise.

It can be further understood that the terms “first”, “second”, etc. are used to describe various information, but the information should not be limited by these terms. These terms are merely used to distinguish the same type of information from each other and do not denote a particular order or degree of importance. Indeed, the expressions “first”, “second”, etc. may be used interchangeably. For instance, first information may also be referred to as second information, and similarly, second information may also be referred to as first information, without departing from the scope of the present disclosure.

It can be further understood the meanings of the words “in response to” and “if” involved in the present disclosure depend on the context and the actual usage scene. For example, the word “in response to” as used herein can be interpreted as “upon” or “when” or “if” or “in case”.

It can be further understood that although the operations in embodiments of the present disclosure are described in a specific order in the drawings, they should not be understood as requiring that the operations are performed in the specific order shown or in a serial order, or that all the operations shown are performed to get the desired result. In certain environments, multitasking and parallel processing may be ad vanlabeleous.

Other implementations of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A method for collecting data, applied to a terminal, and comprising:
receiving data collection indication information; and
measuring a reference signal based on the data collection indication information to obtain sample data.

2. The method according to claim 1, wherein the sample data comprises input sample data, and the input sample data is used as an input when a beam prediction model is operated;
the reference signal comprises a reference signal in a first reference signal set and/or a second reference signal set, an input of the beam prediction model is beam information corresponding to the reference signal in the first reference signal set, an output of the beam prediction model is beam information or preferred beam information corresponding to the reference signal in the second reference signal set, and the input sample data comprises at least one of the following parameters:
beam information of a first transmit beam corresponding to the reference signal in the first reference signal set, or beam information of a first beam pair corresponding to the reference signal in the first reference signal set, wherein the first beam pair comprises the first transmit beam and a first receive beam;
a reference signal identifier of the reference signal in the first reference signal set;
a first receive beam identifier; or
a first beam pair identifier.

3. The method according to claim 1 or 2, wherein the sample data comprises sample label data, and the sample label data is used as a label when a beam prediction model is operated;
in response to a first reference signal set, a second reference signal set and an output of the beam prediction model satisfying a first condition, the sample label data comprises at least one of the following parameters:
beam information of a second transmit beam corresponding to a reference signal in the second reference signal set, or beam information of a second beam pair corresponding to the reference signal in the second reference signal set, wherein the second beam pair comprises the second transmit beam and a second receive beam;
a reference signal identifier of the reference signal in the second reference signal set;
a second receive beam identifier; or
a second beam pair identifier.

4. The method according to claim 3, wherein the first condition comprises at least one of:
the first reference signal set and the second reference signal set being different, and the output of the beam prediction model being beam information corresponding to the second reference signal set; or
the first reference signal set being a subset of the second reference signal set, or the first reference signal set being the same as the second reference signal set, and the output of the beam prediction model being the beam information corresponding to the second reference signal set.

5. The method according to claim 1 or 2, wherein the sample data comprises sample label data, and the sample label data is used as a label when a beam prediction model is operated; and
in response to a first reference signal set, a second reference signal set and an output of the beam prediction model satisfying a second condition, the sample label data comprises an identifier of a preferred transmit beam or an identifier of a third beam pair in the second reference signal set, and the third beam pair comprises the preferred transmit beam and a preferred receive beam.

6. The method according to claim 5, wherein the second condition comprises at least one of:
the first reference signal set and the second reference signal set being different, and the output of the beam prediction model being preferred beam information; or
the first reference signal set being a subset of the second reference signal set, or the first reference signal set being the same as the second reference signal set, and the output of the beam prediction model being the preferred beam information.

7. The method according to any one of claims 1 to 6, wherein the sample data comprises at least one of the following parameters:
the amount of sample data;
a scene and/or a sample parameter corresponding to the sample data;
a beam prediction model identifier and/or a beam prediction model function; or
a timestamp corresponding to the sample data.

8. The method according to any one of claims 1 to 7, wherein the sample data is configured to operate a beam prediction model, and the data collection indication information at least comprises measurement configuration information; and
the measurement configuration information comprises at least one of the following information:
at least one reference signal set;
a data collection start time; or
a data collection end time.

9. The method according to claim 8, wherein the beam prediction model is operated on the terminal; and
the method further comprises:
sending a data collection request, wherein the data collection request is configured to indicate a network device to configure the data collection indication information.

10. The method according to claim 9, wherein the data collection request comprises at least one of the following parameters:
the amount of sample data; or
reference signal set configuration information.

11. The method according to claim 8, wherein the data collection indication information further comprises report configuration information; and
the report configuration information is configured to indicate at least one of the following reporting manners:
periodic reporting;
aperiodic reporting; or
radio resource control (RRC) signaling or uplink control information (UCI)-based reporting.

12. The method according to claim 11, wherein the beam prediction model is operated on a network device;
measuring the reference signal based on the data collection indication information to obtain the sample data comprises:
measuring the reference signal based on the measurement configuration information to obtain the sample data; and
the method further comprises:
sending the sample data based on the report configuration information.

13. The method according to claim 11 or 12, wherein in response to the report configuration information being configured to indicate the periodic reporting, sending the sample data comprises sending one or more pieces of sample data.

14. The method according to claim 11 or 12, wherein in response to the report configuration information being configured to indicate the aperiodic reporting, the sample data at least comprises the amount of sample data.

15. The method according to claim 11 or 12, wherein in response to the report configuration information being configured to indicate the RRC signaling or UCI-based reporting, sending the sample data comprises sending the sample data through a physical uplink shared channel (PUSCH) or a physical uplink control channel (PUCCH).

16. The method according to any one of claims 2 to 15, wherein operating the beam prediction model comprises at least one of:
training the beam prediction model;
monitoring the beam prediction model; or
performing deduction based on the beam prediction model.

17. A method for collecting data, applied to a network device, and comprising:
sending data collection indication information, wherein the data collection indication information is configured to indicate to a terminal to measure a reference signal to obtain sample data.

18. The method according to claim 17, wherein the sample data comprises input sample data, and the input sample data is used as an input when a beam prediction model is operated;
the reference signal comprises a reference signal in a first reference signal set and/or a second reference signal set, an input of the beam prediction model is beam information corresponding to the reference signal in the first reference signal set, an output of the beam prediction model is beam information or preferred beam information corresponding to the reference signal in the second reference signal set, and the input sample data comprises at least one of the following parameters:
beam information of a first transmit beam corresponding to the reference signal in the first reference signal set, or beam information of a first beam pair corresponding to the reference signal in the first reference signal set, wherein the first beam pair comprises the first transmit beam and a first receive beam;
a reference signal identifier of the reference signal in the first reference signal set;
a first receive beam identifier; or
a first beam pair identifier.

19. The method according to claim 17 or 18, wherein the sample data comprises sample label data, and the sample label data is used as a label when a beam prediction model is operated;
in response to a first reference signal set, a second reference signal set and an output of the beam prediction model satisfying a first condition, the sample label data comprises at least one of the following parameters:
beam information of a second transmit beam corresponding to a reference signal in the second reference signal set, or beam information of a second beam pair corresponding to the reference signal in the second reference signal set, wherein the second beam pair comprises the second transmit beam and a second receive beam;
a reference signal identifier of the reference signal in the second reference signal set;
a second receive beam identifier; or
a second beam pair identifier.

20. The method according to claim 19, wherein the first condition comprises at least one of:
the first reference signal set and the second reference signal set being different, and the output of the beam prediction model being beam information corresponding to the second reference signal set; or
the first reference signal set being a subset of the second reference signal set, or the first reference signal set being the same as the second reference signal set, and the output of the beam prediction model being the beam information corresponding to the second reference signal set.

21. The method according to claim 17 or 18, wherein the sample data comprises sample label data, and the sample label data is used as a label when a beam prediction model is operated; and
in response to a first reference signal set, a second reference signal set and an output of the beam prediction model satisfying a second condition, the sample label data comprises an identifier of a preferred transmit beam or an identifier of a third beam pair in the second reference signal set, and the third beam pair comprises the preferred transmit beam and a preferred receive beam.

22. The method according to claim 21, wherein the second condition comprises at least one of:
the first reference signal set and the second reference signal set being different, and the output of the beam prediction model being preferred beam information; or
the first reference signal set being a subset of the second reference signal set, or the first reference signal set being the same as the second reference signal set, and the output of the beam prediction model being the preferred beam information.

23. The method according to any one of claims 17 to 22, wherein the sample data comprises at least one of the following parameters:
the amount of sample data;
a scene and/or a sample parameter corresponding to the sample data;
a beam prediction model identifier and/or a beam prediction model function; or
a timestamp corresponding to the sample data.

24. The method according to any one of claims 17 to 23, wherein the sample data is configured to operate a beam prediction model, and the data collection indication information at least comprises measurement configuration information; and
the measurement configuration information comprises at least one of the following information:
at least one reference signal set;
a data collection start time; or
a data collection end time.

25. The method according to claim 24, wherein the beam prediction model is operated on the terminal; and
the method further comprises:
receiving a data collection request, wherein the data collection request is configured to indicate to the network device to configure the data collection indication information.

26. The method according to claim 25, wherein the data collection request comprises at least one of the following parameters:
the amount of sample data; or
reference signal set configuration information.

27. The method according to claim 24, wherein the data collection indication information further comprises report configuration information; and
the report configuration information is configured to indicate at least one of the following reporting manners:
periodic reporting;
aperiodic reporting; or
radio resource control (RRC) signaling or uplink control information (UCI)-based reporting.

28. The method according to claim 27, wherein the beam prediction model is operated on the network device, wherein the data collection indication information is configured to indicate to the terminal to measure the reference signal to obtain the sample data, and the report configuration information is configured to indicate to the terminal to send the sample data; and
the method further comprises:
receiving the sample data.

29. The method according to claim 27 or 28, wherein in response to the report configuration information being configured to indicate the periodic reporting, receiving the sample data comprises receiving one or more pieces of sample data.

30. The method according to claim 27 or 28, wherein in response to the report configuration information being configured to indicate the aperiodic reporting, the sample data at least comprises the amount of sample data.

31. The method according to claim 27 or 28, wherein in response to the report configuration information being configured to indicate the RRC signaling or UCI-based reporting, receiving the sample data comprises receiving the sample data through a physical uplink shared channel (PUSCH) or a physical uplink control channel (PUCCH).

32. The method according to any one of claims 18 to 15, wherein operating the beam prediction model comprises at least one of:
training the beam prediction model;
monitoring the beam prediction model; or
performing deduction based on the beam prediction model.

33. An apparatus for collecting data, configured in a terminal, and comprising:
a receiving module, configured to receive data collection indication information; and
a processing module, configured to measure a reference signal based on the data collection indication information to obtain sample data.

34. An apparatus for collecting data, configured in a network device, and comprising:
a sending module, configured to send data collection indication information, wherein the data collection indication information is configured to indicate to a terminal to measure a reference signal to obtain sample data.

35. A device for collecting data, comprising:
a processor; and
a memory, configured to store executable instructions of the processor;
wherein the processor is configured to execute the method according to any one of claims 1 to 16.

36. A device for collecting data, comprising:
a processor; and
a memory, configured to store executable instructions of the processor;
wherein the processor is configured to execute the method according to any one of claims 17 to 32.

37. A non-transitory computer-readable storage medium, wherein instructions in the storage medium, when executed by a processor of a terminal, enables the terminal to perform the method according to any one of claims 1 to 16.

38. A non-transitory computer-readable storage medium, wherein instructions in the storage medium, when executed by a processor of a network device, enables the network device to perform the method according to any one of claims 17 to 32.
